(19) United States
(12) Patent Application Publication
(10) Pub. No.: US 2025/0038771 A1
(43) Pub. Date: Jan. 30, 2025

(54) Multiplexing Filter Circuit with Shared Ports

(71) Applicant: RF360 Singapore Pte. Ltd., Republic Plaza (SG)

(72) Inventors: Bambang Kunardi, Singapore (SG); Chee Khoon Eng, Singapore (SG); Sean Chun-Hsiang Yang, San Diego, CA (US)

(21) Appl. No.: 18/619,709

(22) Filed: Mar. 28, 2024

Related U.S. Application Data
(60) Provisional application No. 63/516,026, filed on Jul. 27, 2023.

(51) Int. Cl. H04B 1/00; H04B 1/40

(52) U.S. Cl. CPC H04B 1/0057; H04B 1/40

(57) ABSTRACT

An apparatus is disclosed for a multiplexing filter circuit (MFC). In example aspects, the MFC includes multiple filters, with each respective filter of the multiple filters having a respective distinct passband that corresponds to a frequency band. The multiple filters include a first group of filters and a second group of filters that is different from the first. The MFC includes a first plurality of nodes coupled between the multiple filters and an antenna port, with the first plurality of nodes including a first node coupled between the first group of filters and the antenna port. The MFC includes a second plurality of nodes coupled between the multiple filters and processing circuitry, with the second plurality of nodes including a first node coupled between the second group of filters and the processing circuitry. The first and second groups of filters each include a filter of the multiple filters in common.

### CROSS-REFERENCE TO RELATED APPLICATION(S)

This Nonprovisional Application claims the benefit of U.S. Provisional Application No. 63/516,026, filed 27 Jul. 2023, the disclosure of which is hereby incorporated by reference in its entirety herein.

### TECHNICAL FIELD

This disclosure relates generally to signal communication or signal processing using an electronic device and, more specifically, to employing a multiplexing filter circuit having shared ports.

### BACKGROUND

Electronic devices include traditional computing devices such as desktop computers, notebook computers, smartphones, wearable devices like a smartwatch, internet servers, and so forth. Electronic devices also include other types of computing devices such as personal voice assistants (e.g., smart speakers), wireless access points or routers, thermostats and other automated controllers, robotics, automotive electronics, devices embedded in other machines like refrigerators and industrial tools, Internet of Things (IoT) devices, medical devices, and so forth. These various electronic devices provide services relating to productivity, communication, social interaction, security, health and safety, remote management, entertainment, transportation, and information dissemination. Thus, electronic devices play crucial roles in modern society.

Many of the services provided by electronic devices in today's interconnected world depend at least partly on electronic communications. Electronic communications can include, for example, those exchanged between two or more electronic devices using wireless or wired signals that are transmitted over one or more networks, such as the Internet, a Wi-Fi® network, or a cellular network. Electronic communications can therefore include wireless or wired transmissions and receptions. To transmit and receive communications, an electronic device can use a transceiver, such as a wireless transceiver that is designed for wireless communications.

Electronic communications can thus be realized by propagating signals between two wireless transceivers at two different electronic devices. For example, using a wireless transmitter, a smartphone can transmit a wireless signal to a base station over the air as part of an uplink communication to support mobile services. Using a wireless receiver, the smartphone can receive a wireless signal that is transmitted from the base station via the air medium as part of a downlink communication to enable mobile services. With a smartphone, mobile services can include making voice and video calls, participating in social media interactions, sending messages, watching movies, sharing videos, and performing searches. Other mobile services can include using map information or navigational instructions, finding friends, engaging in location-based services generally, transferring money, obtaining another service like a car ride, and so forth.

Many of these mobile services depend at least partly on the transmission or reception of wireless signals between two or more electronic devices. Consequently, researchers, electrical engineers, and designers of electronic devices strive to develop wireless transceivers and other wireless hardware that can use wireless signals effectively to provide these and other mobile services.

### SUMMARY

A wireless transceiver or a radio-frequency (RF) front-end can include a filter that passes the desired frequencies of a signal but suppresses the undesired ones. Among other functions, filters can support carrier aggregation, which enables a user to communicate with higher bandwidth by assigning multiple carriers to the user. Employing carrier aggregation, especially as the number of available frequency bands increases, entails incorporating additional circuitry such as switching components and “replicated” amplifiers. This additional circuitry increases the cost and size of electronic devices. To at least reduce an amount of such additional circuitry, this document describes a multiplexing filter circuit having shared ports. In example implementations, the multiplexing filter circuit can include multiple filters with shared input ports and shared output ports. In some cases, this can produce filter groups that differ with respect to the shared input ports as compared to the shared output ports. For instance, four filters that are arranged as two diplexers with respect to the shared input ports may be arranged as two different diplexers with respect to the shared output ports based on how nodes are coupled together. This arrangement can obviate the use of additional switch throws and/or additional amplifiers to lower costs and reduce device size.

In an example aspect, an apparatus for a multiplexing filter circuit is disclosed. The apparatus includes at least one multiplexing filter circuit, a first plurality of nodes, and a second plurality of nodes. The at least one multiplexing filter circuit includes multiple filters, with each respective filter of the multiple filters having a respective distinct passband that corresponds to a frequency band. The multiple filters include a first group of filters and a second group of filters that is different from the first group of filters. The first plurality of nodes is coupled between the multiple filters and at least one antenna port, with the first plurality of nodes including a first node coupled between the first group of filters and the at least one antenna port. The second plurality of nodes is coupled between the multiple filters and processing circuitry, with the second plurality of nodes including a first node coupled between the second group of filters and the processing circuitry. The first group of filters and the second group of filters each include at least one filter of the multiple filters in common.

In an example aspect, a method for operating a multiplexing filter circuit is disclosed. The method includes propagating a first signal through a first common input port. The method also includes filtering the first signal with a first filter to produce a first filtered signal and filtering the first signal with a second filter to produce a second filtered signal. The method additionally includes routing the first filtered signal to a first common output port and routing the second filtered signal to a second common output port. The method also includes propagating a second signal through a second common input port. The method additionally includes filtering the second signal with a third filter to produce a third filtered signal and filtering the second signal with a fourth filter to produce a fourth filtered signal. The method further includes routing the third filtered signal to the second common output port and routing the fourth filtered signal to the first common output port.

In an example aspect, an apparatus related to a multiplexing filter circuit is disclosed. The apparatus includes at least one multiplexing filter circuit having multiple filters. Each respective filter of the multiple filters corresponds to a respective distinct passband that is associated with a respective frequency band. The multiple filters include a first set of filters forming at least a first filter group and a second set of filters forming at least a second filter group, with the first filter group being different from the second filter group. The apparatus also includes a first plurality of nodes coupled between the first set of filters and at least one antenna port. The apparatus further includes a second plurality of nodes coupled between the second set of filters and processing circuitry.

### BRIEF DESCRIPTION OF DRAWINGS

FIG. 1 illustrates an environment with an example electronic device that has a wireless interface device, which includes at least one example multiplexing filter circuit with shared ports.

FIG. 2-1 is a schematic diagram illustrating an example radio-frequency (RF) front-end and an example transceiver that can each include at least one multiplexing filter circuit.

FIG. 2-2 is a schematic diagram illustrating an example RF front-end (RFFE) that can include one or more multiplexing filter circuits coupled between at least one antenna and one or more amplifiers.

FIG. 3 is a schematic diagram illustrating an example multiplexing filter circuit with multiple filters in which ports can be shared differently on a first side (e.g., an input side) versus a second side (e.g., an output side).

FIGS. 4-1 to 4-3 are schematic diagrams illustrating example multiplexing filter circuits with four filters that are coupled between a switching circuit and multiple amplifiers.

FIGS. 5-1 to 5-3 are schematic diagrams illustrating example multiplexing filter circuits with different quantities of filters and different couplings to antennas or shared ports.

FIGS. 6-1 to 6-3 are block and schematic diagrams of example multiplexing filter circuits that employ two or more duplexers or at least one quadplexer.

FIGS. 7-1 to 7-3 are schematic diagrams of example multiplexing filter circuits that employ multiple diplexers or duplexers that are coupled together in different manners.

FIG. 8 is a flow diagram illustrating an example process for operating at least one multiplexing filter circuit.

### DETAILED DESCRIPTION

### Introduction and Overview

To facilitate transmission and reception of wireless signals, an electronic device can use a wireless interface device that includes a wireless transceiver and/or a radio-frequency (RF) front-end. Electronic devices communicate with wireless signals using electromagnetic (EM) signals in various frequencies that exist on a portion of the EM spectrum. These wireless signals may travel between two electronic devices at a particular frequency, such as a kilohertz (kHz) frequency, a megahertz (MHz) frequency, or a gigahertz (GHz) frequency. The EM spectrum is, however, a finite resource that limits how many signals can be simultaneously communicated in any given spatial area. There are already billions of electronic devices that use this limited resource. To enable a greater number of simultaneous communications using EM signaling, the finite EM spectrum can be shared among electronic devices. The EM spectrum can be shared using, for instance, frequency division multiplexing (FDM) and/or time division multiplexing (TDM) techniques.

Techniques for FDM or TDM can entail separating the EM spectrum into different frequency bands and constraining communications to occur within an assigned frequency band and/or during a specified time (e.g., a timeslot). Signals in different frequency bands can be communicated at the same time in a common area (e.g., in free space or along a wire) without significantly interfering with each other. To transmit a signal within a target frequency band, a transmitter can apply a filter to the signal. The filter passes the frequencies of the target frequency band and suppresses (e.g., attenuates, reduces, or blocks) other frequencies. Thus, filters can support FDM and/or TDM techniques to facilitate efficient sharing of the EM spectrum.

A wireless transceiver or an RF front-end of an electronic device can include at least one filter that passes the desired frequencies of a signal (e.g., a frequency passband) within a target frequency band but suppresses the undesired ones outside of the targeted band. Some filters use combinations of inductors and capacitors to suppress frequencies. Additionally or alternatively, some filters use acoustic resonators (e.g., a microacoustic resonator), like a bulk acoustic wave (BAW) resonator or a surface acoustic wave (SAW) resonator, to filter frequencies using a piezoelectric material. Such filters may be referred to as an acoustic filter or a microacoustic filter. Each acoustic resonator may be associated with a resonant frequency that corresponds to which frequency or frequencies can be passed or suppressed using the acoustic resonator. Filters can also include other components, such as one or more transformers to act as a balun to process balanced and unbalanced signals.

Thus, to achieve a desired filter response, filters can use acoustic resonators, capacitors, inductors, transformers, combinations thereof, and so forth. Further, some electronic devices have multiple instances of such filters to enable communication across different frequency bands. With Fifth-Generation (5G) and forthcoming Sixth-Generation (6G) technologies, filters that service numerous frequency bands may be “crowded” into a single device. For example, an electronic device may include additional filter circuits to support carrier aggregation (CA) in which a communication involves signaling across multiple carrier frequencies to increase bandwidth. For instance, an active carrier aggregation combination may cover a first frequency band and a second frequency band to provide a user a given amount of bandwidth. To do so, a device may include multiplexing circuits such as “unidirectional” n-plexers (e.g., a diplexer, triplexer, quadplexes, or quintplexer) or “bidirectional” n-plexers (e.g., a duplexer).

Further, devices are expected to allow for an increasing number of frequency bands that enable 5G features by permitting high-bandwidth and low latency applications to become a reality. Additional filters (e.g., RF filters) are to be deployed for these frequency bands, but these additional filters create new challenges in the complexity of a wireless interface device. With respect to an RF front-end (RFFE) of a wireless interface device, for example, it can be challenging to allocate sufficient area, or real-estate on a printed circuit board (PCB), to enable so many RF filters to be incorporated into the RF front-end.

Generally, advantages can be gained through the simplification of, e.g., RF architecture with a higher integration of the frequency bands offered by various specifications of the 3^{rd} Generation Partnership Project (3GPP), such as 3^{rd} Generation (3G), 4G, 5G, 6G, and future generations. For example, a quantity of ports used for a given number of filters can be lowered by implementing port sharing as described herein. Port sharing can result in a reduction in the number of components that are used to provide a given level of functionality, such as a given quantity of frequency bands that are enabled by a device. Examples of components that are candidates for reduction include switches, power amplifiers, and/or low-noise amplifiers, but other components may also be reduced in quantity. Port sharing can also simplify the routing between various components, such as the routing of traces on a PCB or wires on an integrated circuit (IC) chip. This can reduce the size of the PCB or IC chip and/or enable other components to be included to offer more features. Fewer routings and components can also reduce the likelihood of signal propagation issues like insertion loss, interference, latency, phase variances, and so forth. Thus, overall RF performance can also be improved through the architecture simplification provided by port sharing.

Further, bill of material (BOM) costs and manufacturing expenses, such as fabrication or assembly efforts, can be lowered with the port sharing approaches described in this document. Generally, in addition to a fiscal cost, each component has a corresponding spatial cost in terms of a physical size that occupies some area or volume within the housing of an electronic device. An additional financial expense or an increased physical size may be particularly relevant factors for price-sensitive or mobile devices. Accordingly, employing a multiplexing filter circuit with shared ports can offer these additional advantages.

Certain example principles and advantages of described implementations are now presented with reference to an example scenario. In this example scenario, at least one inter-band downlink carrier aggregation (DLCA) communication is established. With one DLCA combination having two bands (e.g., bands B3 and B1), one 2-in-1 diplexer can be deployed in a receive chain to support the two bands. With two DLCA combinations having two bands apiece (e.g., bands B3+B1 and bands B39+B41), two 2-in-1 diplexers can be deployed in a receive chain to support the four bands. Here, each 2-in-1 diplexer may include two filters.

In one approach with two 2-in-1 diplexers, four low-noise amplifiers (LNAs) are used in the receive chain to accommodate the four bands (e.g., one LNA per band or per filter). In other words, each filter of the four total filters that are spread across the four outputs of the two diplexers provide a respective signal to a respective LNA of the four LNAs. In another approach with two 2-in-1 diplexers, to reduce the number of LNAs from four to two, two switches are employed. Each switch of the two switches can selectively couple an output from one of two filters to an LNA of the two LNAs. Accordingly, employing two switches can reduce the LNA total from four to two LNAs. Thus, in the former approach, four LNAs are employed to process four output signals from the two 2-in-1 diplexers for the four frequency bands. In the latter approach, in contrast, just two LNAs but two switches are employed to process four output signals from the two 2-in-1 diplexers for the four bands.

Other approaches are presented herein to enable multiple communications at multiple frequencies (e.g., in a scenario with an active carrier aggregation or active carrier aggregation combination) to be performed with a reduced component count. This document describes apparatuses and techniques in which filter ports are shared in a multiplexing circuit environment to reduce component count and simplify the architecture. With reference to the example presented above for two 2-in-1 diplexers, the component count can be reduced to only two LNAs with no switches using port sharing.

As described herein, a filter circuit is architected to share ports through multiplexing so as to reduce a number of ports (e.g., input ports or output ports) that the filter circuit has or employs. In a receive chain example, a number of output ports, which are coupled to inputs of separate low-noise amplifiers, of the multiplexing circuit can be reduced. In a transmit chain example, a number of input ports, which are coupled to separate outputs of power amplifiers, of the multiplexing circuit can be reduced.

In example implementations, a multiplexing filter circuit includes multiple filters. A subset of the inputs or outputs of the “individual” filters of the multiple filters are coupled together. These inputs or outputs may be coupled together without a switch, such as via a common node. In some cases, to perform such port sharing, two or more filters sharing the same (e.g., output) port may be codesigned such that they do not unduly load each other and thereby deteriorate the filtering performance of an active filter when one or more other coupled filters are inactive. For example, two or more acoustic resonator filters that are coupled together may be designed to have a low loading impact on each other. More generally, two or more filters that are coupled together may be tuned to have a low loading impact on each other with the addition of at least one other component. For instance, a shunt impedance (e.g., an inductor or a capacitor) may be coupled to the port (e.g., the node) that is shared by the two or more filters. Additional example implementations for multiplexing filter circuits having shared ports are described herein.

By reducing a number of input or output ports of a filter circuit through port sharing, a quantity of amplifiers or switches that are used to incorporate the filter circuit into a transmit or receive chain can be lowered. Port sharing can also increase an integration level of a filter that is functioning within a package. The increased integration can result in a smaller volume being occupied in the device and/or a smaller area being occupied on a PCB. For instance, a two-module or two-package implementation may be compacted into a one-module or one-package implementation. The one-module/package approach may be larger than an individual module/package of the two-module/package approach in some situations, but the total size (e.g., area or volume) can be lower. Further, simplified routings of conducting elements such as wires or traces can provide an additional area reduction. Because of such increased integration, costs at the product level can be lowered. An electronic device, for instance, can thus have a lower cost and/or a smaller form factor for easer portability. Moreover, the synergy of these effects can improve overall filtering performance, including the performance of RF signal processing by facilitating signal propagation.

### Description Examples

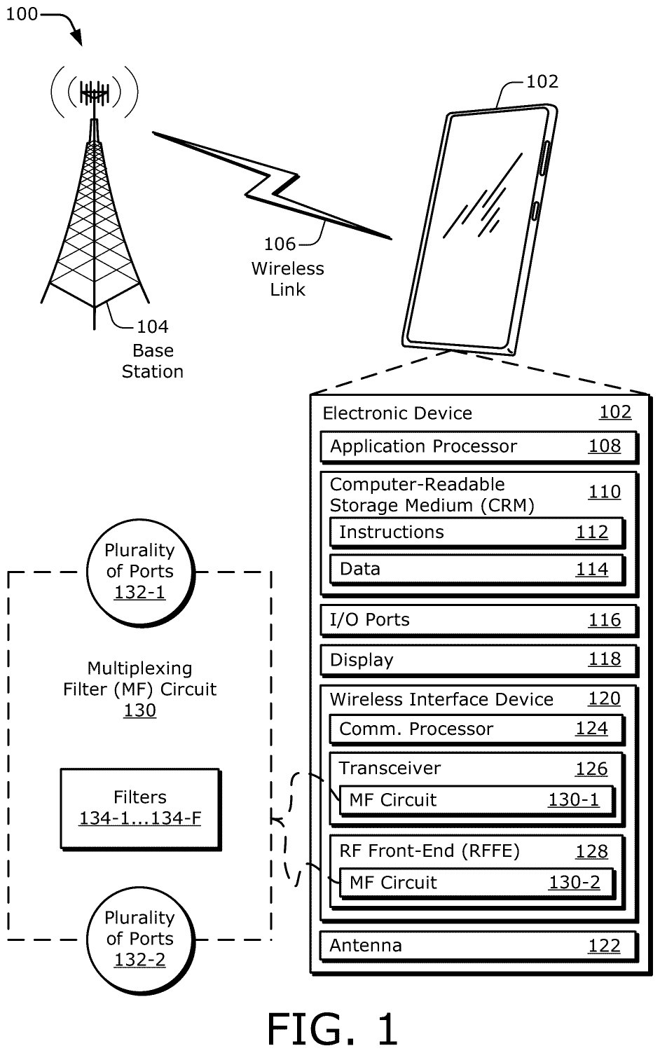

FIG. 1 illustrates an example environment 100 with an electronic device 102 that has a wireless interface device 120, which includes at least one example multiplexing filter circuit 130. This document describes example implementations of the multiplexing filter circuit 130, which may be part of a transceiver, a radio-frequency front-end (RFFE), and so forth of an apparatus. In the environment 100, the example electronic device 102 communicates with a base station 104 through a wireless link 106. In FIG. 1, the electronic device 102 is depicted as a smartphone. The electronic device 102, however, may be implemented as any suitable computing or other electronic device. Examples of an apparatus that can be realized as an electronic device 102 include a cellular base station, broadband router, access point, cellular or mobile phone, gaming device, navigation device, media device, laptop computer, desktop computer, tablet computer, server computer, network-attached storage (NAS) device, smart appliance, vehicle-based communication system, Internet of Things (IoT) device, sensor or security device, asset tracker, fitness management device, wearable device such as intelligent glasses or smartwatch, wireless power device (transmitter or receiver), medical device, and so forth.

The base station 104 communicates with the electronic device 102 via the wireless link 106, which may be implemented as any suitable type of wireless link that carries a communication signal. Although depicted as a base station tower of a cellular radio network, the base station 104 may represent or be implemented as another device, such as a satellite, terrestrial broadcast tower, access point, peer-to-peer device, mesh network node, fiber optic line interface, another electronic device as described above generally, and so forth. Hence, the wireless link 106, or an extension thereof, can connect between the electronic device 102 and the base station 104 in any of various manners.

The wireless link 106 can include a downlink of data or control information communicated from the base station 104 to the electronic device 102. The wireless link 106 can also include an uplink of other data or control information communicated from the electronic device 102 to the base station 104. The wireless link 106 may be implemented using any suitable wireless communication protocol or standard. Examples of such protocols and standards include a 3^{rd} Generation Partnership Project (3GPP) Long-Term Evolution (LTE) standard, such as a 4^{th} Generation (4G), a 5^{th} Generation (5G), or a 6^{th} Generation (6G) cellular standard; an IEEE 802.11 standard, such as 802.11g, ac, ax, ad, aj, or ay standard (e.g., Wi-Fi® 6 or WiGig®); an IEEE 802.16 standard (e.g., WiMAX®); a Bluetooth® standard; an ultra-wideband (UWB) standard (e.g., IEEE 802.15.4); and so forth. In some implementations, the wireless link 106 may provide power wirelessly, and the electronic device 102 or the base station 104 may comprise a power source.

As shown for some implementations, the electronic device 102 can include at least one application processor 108 and at least one computer-readable storage medium 110 (CRM 110). The application processor 108 may include any type of processor, such as a central processing unit (CPU) or a multi-core processor, that is configured to execute processor-executable instructions (e.g., code) stored by the CRM 110. The CRM 110 may include any suitable type of data storage media, such as volatile memory (e.g., random-access memory (RAM)), non-volatile memory (e.g., Flash memory), optical media, magnetic media (e.g., disk or tape), and so forth. In the context of this disclosure, the CRM 110 is implemented to store instructions 112, data 114, and other information of the electronic device 102, and thus the CRM 110 does not include transitory propagating signals or carrier waves.

The electronic device 102 may also include one or more input/output ports 116 (I/O ports 116) and at least one display 118. The I/O ports 116 enable data exchanges or interaction with other devices, networks, or users. The I/O ports 116 may include serial ports (e.g., universal serial bus (USB®) ports), parallel ports, ethernet ports, audio ports, infrared (IR) ports, cameras or other sensor ports, and so forth. The display 118 can be realized as a display screen or a projection that presents graphical images provided by other components of the electronic device 102, such as a user interface (UI) associated with an operating system, program, or application. Alternatively or additionally, the display 118 may be implemented as a display port or virtual interface through which graphical content of the electronic device 102 is communicated or presented.

The electronic device 102 further includes at least one wireless interface device 120 and at least one antenna 122. The example wireless interface device 120 provides connectivity to respective networks and peer devices via a wireless link, which may be configured similarly to or differently from the wireless link 106. The wireless interface device 120 may facilitate communication over any suitable type of wireless network, such as a wireless local area network (LAN) (WLAN), wireless personal-area-network (PAN) (WPAN), peer-to-peer (P2P) network, mesh network, cellular network, wireless wide-area-network (WAN) (WWAN), and/or navigational network (e.g., the Global Positioning System (GPS) of North America or another Satellite Positioning System (SPS) or Global Navigation Satellite System (GNSS)). In the context of the example environment 100, the electronic device 102 can communicate various data and control information bidirectionally with the base station 104 via the wireless interface device 120. The electronic device 102 may, however, communicate directly with other peer devices, an alternative wireless network, and the like. Also, as described above, an electronic device 102 may alternatively be implemented as a base station 104 or another apparatus as set forth herein.

As shown, the wireless interface device 120 can include at least one communication processor 124, at least one transceiver 126 (e.g., a wireless transceiver 126), and at least one radio-frequency front-end 128 (RFFE 128). These components process data information, control information, and signals associated with communicating information for the electronic device 102 via the antenna 122. The communication processor 124 may be implemented as at least part of a system-on-chip (SoC), as a modem processor, or as a baseband radio processor (BBP) that enables a digital communication interface for data, voice, messaging, or other applications of the electronic device 102. The communication processor 124 can include a digital signal processor (DSP) or one or more signal-processing blocks (not shown) for encoding and modulating data for transmission and for demodulating and decoding received data. Additionally, the communication processor 124 may also manage (e.g., control or configure) aspects or operation of the transceiver 126, the RF front-end 128, and other components of the wireless interface device 120 to implement various communication protocols or communication techniques.

In some cases, the application processor 108 and the communication processor 124 can be combined into one module or integrated circuit (IC), such as an SoC. Regardless, the application processor 108, the communication processor 124, or a processor generally can be operatively coupled to one or more other components, such as the CRM 110 or the display 118, to enable control of, or other interaction with, the various components of the electronic device 102. For example, at least one processor 108 or 124 can present one or more graphical images on a display screen implementation of the display 118 based on one or more wireless signals transmitted or received via the at least one antenna 122 using components of the wireless interface device 120. Further, the application processor 108 or the communication processor 124, including a combination thereof, can be realized using digital circuitry that implements logic or functionality that is described herein. Additionally, the communication processor 124 may also include or be associated with a memory (not separately depicted) to store data and processor-executable instructions (e.g., code), such as the same or another CRM 110.

As shown, the wireless interface device 120 can include at least one multiplexing filter (MF) circuit 130, which is described below. More specifically, the transceiver 126 can include at least one multiplexing filter circuit 130-1 (MF circuit 130-1), or the RF front-end 128 can include at least one multiplexing filter circuit 130-2 (MF circuit 130-2) (including both components can have at least one multiplexing filter circuit 130 in accordance with an optional but permitted inclusive-or interpretation of the word “or”). The transceiver 126 can also include circuitry and logic for filtering, switching, amplification, channelization, frequency translation, and so forth. Frequency translation functionality may include an up-conversion or a down-conversion of frequency that is performed through a single conversion operation (e.g., with a direct-conversion architecture) or through multiple conversion operations (e.g., with a superheterodyne architecture). Generally, the transceiver 126 can include filters, switches, amplifiers, mixers, and so forth for routing and conditioning signals that are transmitted or received via the antenna 122.

In addition to the multiplexing filter circuit 130-1, the transceiver 126 can include an analog-to-digital converter (ADC) or a digital-to-analog converter (DAC) (not shown in FIG. 1). In operation, an ADC can convert analog signals to digital signals, and a DAC can convert digital signals to analog signals. Generally, an ADC or a DAC can be implemented as part of the communication processor 124, as part of the transceiver 126, or separately from both (e.g., as another part of an SoC or as part of the application processor 108).

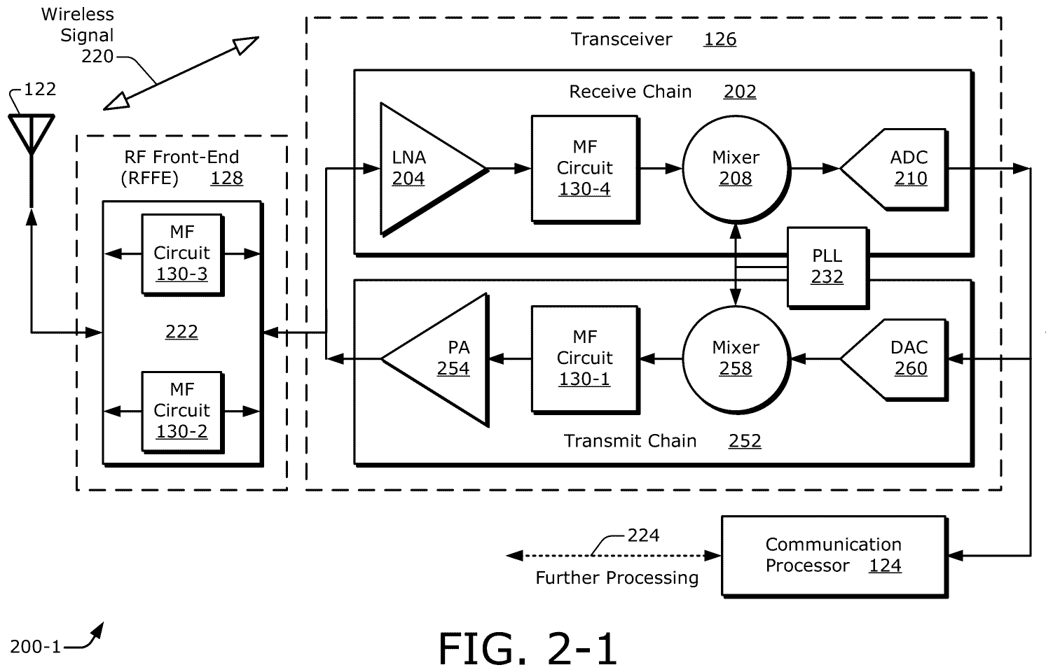

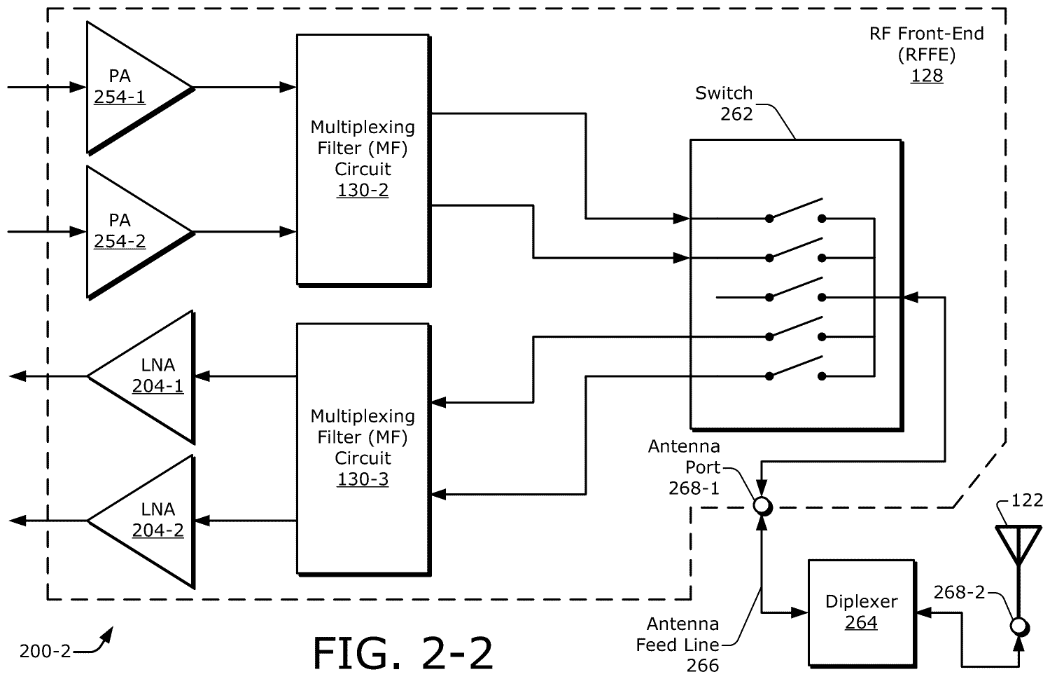

The components or circuitry of the transceiver 126 can be implemented in any suitable fashion, such as with combined transceiver logic or separately as respective transmitter and receiver entities. In some cases, the transceiver 126 is implemented with multiple or different sections to implement respective transmitting and receiving operations (e.g., with separate transmit and receive chains as depicted in FIG. 2). Although not shown in FIG. 1, the transceiver 126 may also include logic to perform in-phase/quadrature (I/Q) operations, such as synthesis, phase correction, modulation, demodulation, and the like.

The RF front-end 128 can include one or more filters-such as the multiplexing filter circuit 130-2-multiple switches, or one or more amplifiers for conditioning signals received via the antenna 122 or for conditioning signals to be transmitted via the antenna 122. The RF front-end 128 may also include a phase shifter (PS), peak detector, power meter, gain control block, antenna tuning circuit, n-plexer, balun, and the like. Configurable components of the RF front-end 128, such as some phase shifters, an automatic gain controller (AGC), or a switch coupled to a multiplexing filter circuit, may be controlled by the communication processor 124 to implement communications in various modes, communications with different frequency bands and/or with carrier aggregation (CA), or communications using beamforming.

In some implementations, the antenna 122 is implemented as at least one antenna array that includes multiple antenna elements. Thus, as used herein, an “antenna” can refer to at least one discrete or independent antenna, to at least one antenna array that includes multiple antenna elements, or to a portion of an antenna array (e.g., an antenna element), depending on context or implementation. At least one antenna 122 may also be part of a module that includes one or more other components (e.g., a multiplexing filter circuit 130-2 or an amplifier) of the RF front-end 128, or the at least one antenna 122 may be a separate component.

In FIG. 1, an example multiplexing filter circuit 130 is depicted as being part of a transceiver 126 as a multiplexing filter circuit 130-1, as being part of an RF front-end 128 as a multiplexing filter circuit 130-2, and so forth. Described implementations of a multiplexing filter circuit 130 can, however, additionally or alternatively be employed in other portions of the wireless interface device 120 or in other portions of the electronic device 102 generally. As set forth above, a multiplexing filter circuit 130 can be included in an electronic device other than a cell phone, such as a base station 104. With a base station (or a mobile phone), a filter component of, e.g., an intermediate frequency (IF) section of a wireless interface device 120 and/or an RF front-end 128 may include a multiplexing filter circuit 130 as described herein. Other electronic device apparatuses that can employ a multiplexing filter circuit 130 include a laptop, communication hardware of a vehicle, a wireless access point, and so forth as described herein.

In example implementations, the multiplexing filter circuit 130 can include at least one instance of a plurality of ports 132 and multiple filters 134-1 . . . 134-F, with F representing an integer greater than one. As illustrated, the multiplexing filter circuit 130 can include a first plurality of ports 132-1 and a second plurality of ports 132-2. In some cases, one plurality of ports can operate as a plurality of input ports, and another plurality of ports can operate as a plurality of output ports for the multiplexing filter circuit 130. These input/output statuses may be switched, however, for a single port or for multiple ports during operation, at least for a bidirectional multiplexing filter circuit 130. Additionally or alternatively, a given plurality of ports 132 may include one or more input ports and one or more output ports (e.g., for a duplexing filter component). Although two plurality of ports 132-1 and 132-2 and F filters 134-1 . . . 134-F are explicitly depicted in FIG. 1, a multiplexing filter circuit 130 may include more or fewer of any of such components, as well as other components that are not shown.

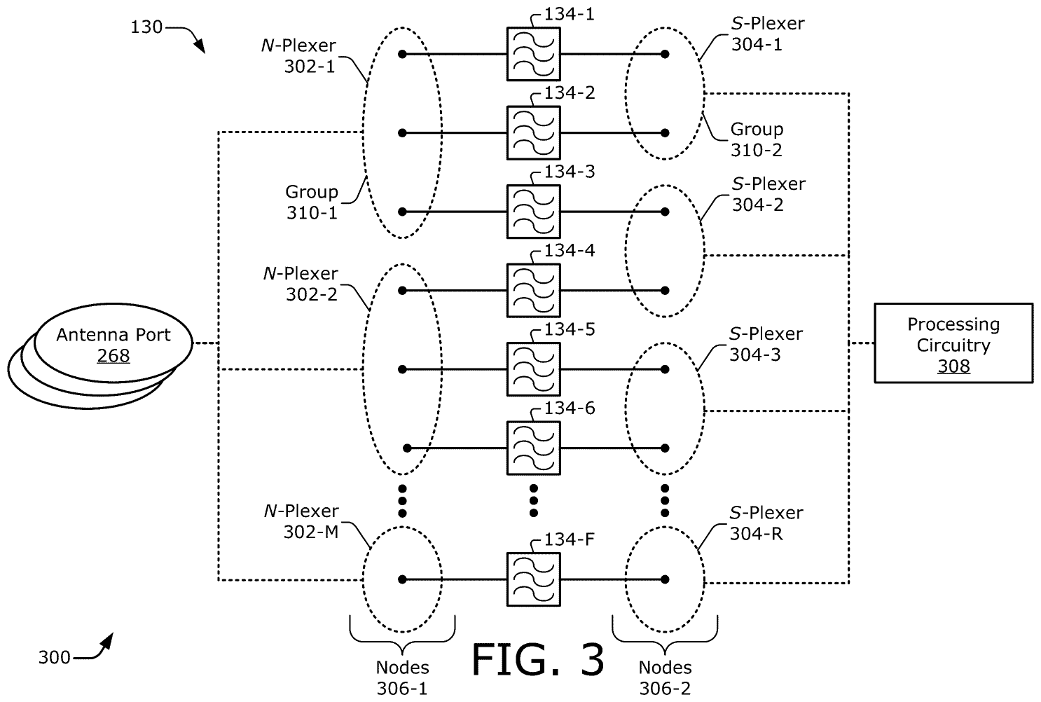

A multiplexing filter circuit 130 can share at least one port of the first plurality of ports 132-1 or the second plurality of ports 132-2 (including may share at least one port in the first and second plurality of ports 132-1 and 132-2 in accordance with a permitted, but not required, interpretation of the word “or” as an “inclusive-or” conjunction). For example, respective filter ports corresponding to an input or an output of respective individual filters of the multiple filters 134-1 to 134-F can be coupled together to share a port of the multiplexing filter circuit 130. Example implementations of port sharing via couplings of nodes are described below with reference to multiple figures, starting with FIG. 3. Next, however, this document describes example implementations of a transceiver and an RF front-end with reference to FIGS. 2-1 and 2-2.

FIG. 2-1 is a schematic diagram 200-1 illustrating an example RF front-end 128 and an example transceiver 126 that can each include at least one multiplexing filter circuit 130. FIG. 2-1 also depicts an antenna 122 and a communication processor 124. The communication processor 124 communicates one or more data signals to other components, such as the application processor 108 of FIG. 1, for further processing at 224 (e.g., for processing at an application level). As shown, the circuitry 200-1 can include a first multiplexing filter circuit 130-1, a second multiplexing filter circuit 130-2, a third multiplexing filter circuit 130-3, or a fourth multiplexing filter circuit 130-4, including one to four of such multiplexing filter circuits. The circuitry 200-1, however, may include a different quantity of filters (e.g., more or fewer multiplexing filter circuits); may include filters that are coupled together differently; may include filters in different locations; may include filters that are implemented with at least one duplexer, diplexer, triplexer, or quadplexer; some combination thereof; and so forth.

As illustrated from left to right, in example implementations, the antenna 122 is coupled to the RF front-end 128, and the RF front-end 128 is coupled to the transceiver 126. The transceiver 126 is coupled to the communication processor 124. The example RF front-end 128 includes at least one signal propagation path 222. The at least one signal propagation path 222 can include at least one multiplexing filter circuit 130, such as the multiplexing filter circuit 130-2 and the multiplexing filter circuit 130-3. The example transceiver 126 includes at least one receive chain 202 (or receive path 202) and at least one transmit chain 252 (or transmit path 252). Although only one RF front-end 128, one transceiver 126, and one communication processor 124 are shown at the circuitry 200-1, an electronic device 102, or a wireless interface device 120 thereof, can include multiple instances of any or all such components. Also, although only certain components are explicitly depicted in FIG. 2 and are shown coupled together in a particular manner, the transceiver 126 or the RF front-end 128 may include other non-illustrated components (e.g., switches or diplexers), more or fewer components, differently coupled arrangements of components, and so forth.

In some implementations, the RF front-end 128 couples the antenna 122 to the transceiver 126 via the signal propagation path 222. In operation, the signal propagation path 222 carries a signal between the antenna 122 and the transceiver 126. During or as part of the signal propagation, the signal propagation path 222 conditions the propagating signal, such as with the multiplexing filter circuit 130-2 or the multiplexing filter circuit 130-3. This enables the RF front-end 128 to couple a wireless signal 220 from the antenna 122 to the transceiver 126 as part of a reception operation. The RF front-end 128 also enables a transmission signal to be coupled from the transceiver 126 to the antenna 122 as part of a transmission operation to emanate a wireless signal 220. Although not explicitly shown in FIG. 2-1, an RF front-end 128, or a signal propagation path 222 thereof, may include one or more other components, such as another filter, an amplifier (e.g., a power amplifier or a low-noise amplifier), an n-plexer, a phase shifter, a diplexer, one or more switches, and so forth.

In some implementations, the transceiver 126 can include at least one receive chain 202, at least one transmit chain 252, or at least one receive chain 202 and at least one transmit chain 252. From left to right, the receive chain 202 can include a low-noise amplifier 204 (LNA 204), the multiplexing filter circuit 130-4, a mixer 208 for frequency down conversion, and an ADC 210. The transmit chain 252 can include a power amplifier 254 (PA 254), the multiplexing filter circuit 130-1, a mixer 258 for frequency up-conversion, and a DAC 260. However, the receive chain 202 or the transmit chain 252 can include other components—for example, additional amplifiers or filters, multiple mixers, one or more buffers, or at least one local oscillator—that are electrically or electromagnetically disposed anywhere along the depicted receive and transmit chains.

The receive chain 202 is coupled between the signal propagation path 222 of the RF front-end 128 and the communication processor 124—e.g., via the low-noise amplifier 204 and the ADC 210, respectively. The transmit chain 252 is coupled between the signal propagation path 222 and the communication processor 124—e.g., via the power amplifier 254 and the DAC 260, respectively. The transceiver 126 can also include at least one phase-locked loop 232 (PLL 232) that is coupled to the mixer 208 or the mixer 258. For example, the transceiver 126 can include one PLL 232 for each transmit/receive chain pair, one PLL 232 per transmit chain and one PLL 232 per receive chain, multiple PLLs 232 per chain, and so forth.

As shown along a signal propagation direction for certain example implementations of the receive chain 202, the antenna 122 is coupled to the low noise amplifier 204 via the signal propagation path 222 and the multiplexing filter circuit 130-3 thereof. The low-noise amplifier 204 is coupled to the multiplexing filter circuit 130-4. The multiplexing filter circuit 130-4 is coupled to the mixer 208, and the mixer 208 is coupled to the ADC 210. The ADC 210 is in turn coupled to the communication processor 124. As shown along a signal propagation direction for certain example implementations of the transmit chain 252, the communication processor 124 is coupled to the DAC 260, and the DAC 260 is coupled to the mixer 258. The mixer 258 is coupled to the multiplexing filter circuit 130-1, and the multiplexing filter circuit 130-1 is coupled to the power amplifier 254. The power amplifier 254 is coupled to the antenna 122 via the signal propagation path 222 using the multiplexing filter circuit 130-2 thereof. Although only one receive chain 202 and one transmit chain 252 are explicitly shown, an electronic device 102, or a transceiver 126 thereof, can include multiple instances of either or both components. Although the ADC 210 and the DAC 260 are illustrated as being separately coupled to the communication processor 124, they may share a bus or other mechanism for communicating with the processor 124. Further, the ADC 210 or the DAC 260 may be part of the communication processor 124 or separate from the transceiver 126 and the communication processor 124.

As part of an example signal-receiving operation, the multiplexing filter circuit 130-3 of the signal propagation path 222 filters a received signal and forwards the filtered signal to the low-noise amplifier 204. The low-noise amplifier 204 accepts the filtered signal from the RF front-end 128 and provides an amplified signal to the multiplexing filter circuit 130-4 based on the accepted signal. The multiplexing filter circuit 130-4 filters the amplified signal and provides another filtered signal to the mixer 208. The mixer 208 performs a frequency conversion operation on the other filtered signal to down-convert from one frequency to a lower frequency (e.g., from a radio frequency (RF) to an intermediate frequency (IF) or from RF or IF to a baseband frequency (BBF)). The mixer 208 can perform the frequency down-conversion in a single conversion step or through multiple conversion steps using at least one PLL 232. The mixer 208 can provide a down-converted signal to the ADC 210 for conversion and forwarding to the communication processor 124 as a digital signal.

As part of an example signal-transmitting operation, the mixer 258 accepts an analog signal at BBF from the DAC 260 (or accepts an analog IF signal if the signal has already been upconverted once by another mixer (not shown)). The mixer 258 upconverts the analog signal to a higher frequency, such as to an RF frequency, to produce an RF signal using a signal generated by the PLL 232 to have a target synthesized frequency. The mixer 258 provides the RF or other upconverted signal to the multiplexing filter circuit 130-1. The multiplexing filter circuit 130-1 filters the RF signal and provides a filtered signal to the power amplifier 254. Thus, after the filtering by the multiplexing filter circuit 130-1, the power amplifier 254 amplifies the filtered signal and provides an amplified signal to the signal propagation path 222 for signal conditioning. Based on the amplified signal, the RF front-end 128 can use, for instance, the multiplexing filter circuit 130-2 of the signal propagation path 222 to provide a filtered signal to the antenna 122 for emanation as a wireless signal 220.

Example implementations of a multiplexing filter circuit 130, as described herein, may be employed at any one or more of the example filter circuits 130-1, 130-2, 130-3, or 130-4 in the transceiver 126 or the RF front-end 128 or at other filters of an electronic device 102 (not shown in FIG. 2-1). The circuitry 200-1, however, depicts just some examples for a transceiver 126 and/or an RF front-end 128. In some cases, the various components that are illustrated in the drawings using separate schematic blocks or circuit elements may be manufactured or packaged in different discrete manners. For example, one physical module may include components of the RF front-end 128 and a portion of the components of the transceiver 126, and another physical module may combine the communication processor 124 with the remaining components of the transceiver 126. Further, in some cases, the antenna 122 may be co-packaged with at least some components of the RF front-end 128 (e.g., may be co-packaged with a multiplexing filter circuit 130 and at least one amplifier as an RF antenna module) or with those of the transceiver 126. Although each filter circuit in FIG. 2-1 is depicted as a multiplexing filter circuit 130 as described herein, any one or more of such filter circuits may instead be implemented as a “non-multiplexing” filter or as a filter circuit that multiplexes signals in a different manner.

In additional or alternative implementations, one or more components may be physically or logically “shifted” to a different part of the wireless interface device 120 as compared to the illustrated circuitry 200-1 and/or may be incorporated into a different module. For example, a low-noise amplifier 204 or a power amplifier 254 may alternatively or additionally be deployed in the RF front-end 128. Examples of this alternative are described next with reference to FIG. 2-2.

FIG. 2-2 is a schematic diagram 200-2 illustrating an example RF front-end 128 that can include one or more multiplexing filter circuits coupled between at least one antenna 122 and one or more amplifiers, such as at least one low-noise amplifier 204 (LNA 204) or at least one power amplifier 254 (PA 254). As illustrated, the RF front-end 128 is coupled to the antenna 122 via an antenna feed line 266. Two example positions of an antenna port 268 for the antenna 122 are shown: a first antenna port 268-1 and a second antenna port 268-2. However, an antenna port 268 may be located elsewhere, including relative to the RF front-end 128.

Between the RF front-end 128 and the antenna 122, the antenna feed line 266 may include one or more components. These one or more components may include a diplexer 264 as shown, or a duplexer in some implementations in which transmit (Tx) and receive (Rx) operations share the antenna 122. The RF front-end 128 can include a first power amplifier 254-1, a second power amplifier 254-2, a first low-noise amplifier 204-1, and a second low-noise amplifier 204-2.

The RF front-end 128 can also include one or more switches, such as a switch 262. Each switch 262 (or switching circuit 262) can include or be realized with an individual switch, multiple switch throws, and so forth. The switch 262 is coupled along a signal propagation path, such as the signal propagation path 222 (of FIG. 2-1) of the RF front-end 128. As depicted with arrows between the illustrated components, the signal propagation path can include a transmit path (generally from left-to-right in FIG. 2-2), a receive path (generally from right-to-left in FIG. 2-2), a transmit path and a receive path, and so forth. The switch 262 can include a switch input (to accept an incoming signal), a switch output (to provide an outgoing signal), or a combination switch input/output. Further, a point of ingress or egress for a switch may be a switch input at one moment and a switch output at another moment or may be simultaneously a switch input and a switch output (e.g., for a duplexer), depending on current signal flow(s). Multiple transmit or receive signal propagation paths may be established at the same time or at different times using the various switch throws of the switch 262 and the appropriate multiplexing filter circuit 130 and power amplifier 254 or low-noise amplifier 204. In some cases, each switch throw of the switch 262 can support signal propagation for a receive or a transmit operation (e.g., signal propagation from the antenna 122 or toward the antenna 122) depending on the architecture of the RF front-end 128.

In example implementations, the RF front-end 128 can further include one or more multiplexing filter circuits, such as the multiplexing filter circuits 130-2 and 130-3. The multiplexing filter circuit 130-2 can be used as part of a transmit path between at least one power amplifier 254, such as the first or second power amplifier 254-1 or 254-2, and the antenna 122. Here, the transmit path may further include the switch 262 and the antenna feed line 266. The multiplexing filter circuit 130-3 can be used as part of a receive path between the antenna 122 and at least one low-noise amplifier 204, such as the first or second low-noise amplifier 204-1 or 204-2. Here, the receive path may also further include the antenna feed line 266 and the switch 262.

The transmit and receive paths can be established, at least partly, using one or more throws of the switch 262. A controller (not shown), which may be part of the communication processor 124 (of FIGS. 1 and 2-1), can position or set the states (e.g., open or closed) of these switches or switch throws based on a transmit mode versus a receive mode, a frequency or band being used for transmission or reception, if carrier aggregation (CA) is in effect, whether a duplexing operation is being performed, and so forth. Although certain components are depicted in FIG. 2-2 in certain arrangements and described above in a particular manner, an RF front-end 128 can include different components, more or fewer components, different couplings or arrangements of components, and so forth. Thus, the multiplexing filter circuits, switches, amplifiers, signal propagation paths, etc. of an RF front-end 128 can be realized or operationally configured in different manners.

Each multiplexing filter circuit 130 can be realized with multiple “standalone” filters (e.g., the multiple filters 134-1 to 134-F of FIG. 1) that are arranged or coupled together as at least one duplexer, diplexer, triplexer, quadplexer, some combination thereof, and so forth. As described herein, a multiplexing filter circuit 130 can be implemented with one or more shared ports. Additionally or alternatively, a multiplexing filter circuit 130 can be implemented by arranging the individual filters 134 into M and R multiplexers, with at least one of M and R representing an integer greater than one. A quantity of multiplexers being realized or operationally utilized may, in some cases, depend on which “side” (e.g., input or output) of the multiplexing filter circuit 130 is being considered. Additionally or alternatively, a quantity of multiplexers being realized or operationally utilized may, in some cases, depend on the perspective of signal flow direction through the multiplexing filter circuit 130. Examples of various multiplexer arrangements for filter circuits, including with respect to signal flows, are described herein, including next with reference to FIG. 3.

FIG. 3 is a schematic diagram 300 illustrating an example multiplexing filter circuit 130, at least one antenna port 268, and processing circuitry 308. The multiplexing filter circuit 130 includes multiple filters 134-1 to 134-F. Specifically, but by way of example only, a first filter 134-1, a second filter 134-2, a third filter 134-3, a fourth filter 134-4, a fifth filter 134-5, a sixth filter 134-6, and up to an Fth filter 134-F are explicitly shown. In example implementations, each respective filter 134 provides a respective corresponding filter response based on an associated passband. The passband can correspond to a frequency band, such as B3, B41, or B66, just to name a few examples. A filter response, and an associated passband, of a filter 134 may correspond to a high-pass filter, a low-pass filter, a bandpass filter, a band-stop filter, and so forth.

Each respective passband can be different with respect to other passbands in a multiplexing filter circuit 130 or a portion thereof (e.g., a given group of filters) to realize distinct passbands for multiple filters. Further, each respective passband can be nonoverlapping relative to other passbands of at least a portion of respective instances of the multiple filters 134-1 to 134-F. In some cases, a filter group or group of filters having filter ports or nodes that are coupled together may have passbands that are nonoverlapping, which may reduce potential interference between two or more propagating signals. Further, multiple filters of a multiplexing filter circuit 130, such as the filters of a given filter group, may have frequency bands that are nonadjacent with respect to each other. Two nonadjacent frequency bands have some nonzero frequency range between them. The frequency range may correspond to another frequency band, a guard band, and so forth. A given filter 134 can include one or more acoustic resonators (e.g., a microacoustic resonator), one or more capacitors, one or more inductors, one or more transformers, combinations thereof, and so forth.

As shown in the schematic diagram 300, the multiplexing filter circuit 130 also includes a first plurality of nodes 306-1 and a second plurality of nodes 306-2. In some cases, the first plurality of nodes 306-1 can correspond to filter inputs of the multiple filters 134-1 to 134-F, and the second plurality of nodes 306-2 can correspond to filter outputs of the multiple filters 134-1 to 134-F, or vice versa. In such cases, a quantity of nodes in the first plurality of nodes 306-1 and in the second plurality of nodes 306-2 may each be equal to F. In other cases, a given plurality of nodes 306 on one “side” of the multiplexing filter circuit 130 may include at least one filter input and at least one filter output.

As depicted by short-dashed lines in FIG. 3, groups of nodes of the first plurality of nodes 306-1 can be coupled together to share one or more first ports of the multiplexing filter circuit 130. Similarly, groups of nodes of the second plurality of nodes 306-2 can be coupled together to share one or more second ports of the multiplexing filter circuit 130. The first ports can be on “an opposite side” of the multiplexing filter circuit 130 as compared to the second ports. These first and second sides can correspond, for example, to an antenna side (e.g., with respect to at least one antenna port 268) and to a processing side (e.g., with respect to processing circuitry 308), or vice versa. A first group 310-1 of the first plurality of nodes 306-1 and a second group 310-2 of the second plurality of nodes 306-2 are explicitly indicated in FIG. 3. Generally, multiple nodes or filter inputs/outputs can be coupled together (e.g., to create a common node) on an IC chip, within a module or package (e.g., but external to an IC chip), on a PCB (e.g., but external to a module or package), and so forth.

In example implementations, the first plurality of nodes 306-1 can be coupled to at least one antenna port 268. Although not shown in FIG. 3, one or more other components may be coupled between the first plurality of nodes 306-1 and the antenna port 268, such as at least one switching circuit, a diplexer, or an amplifier. The second plurality of nodes 306-2 can be coupled to processing circuitry 308. The processing circuitry 308 can include, by way of example only, an amplifier, such as a low-noise amplifier or a power amplifier, another filter, a mixer or frequency converter, or digital baseband circuitry.

Although not shown in FIG. 3, one or more other components may be coupled between the second plurality of nodes 306-2 and the processing circuitry 308. Nonetheless, in example aspects, such other components omit a switch (e.g., a switching circuit) between the second plurality of nodes 306-2 and the processing circuitry 308. Thus, each filter 134 can be coupled to at least one amplifier without an intervening switch. This can produce an unswitched coupling between a filter port, or filter input or filter output, and one or more amplifiers (e.g., a power amplifier or a low-noise amplifier).

In some implementations, the multiplexing filter circuit 130 can be coupled between the first plurality of nodes 306-1 and the second plurality of nodes 306-2. The multiple filters 134-1 to 134-F of the multiplexing filter circuit 130 can present as or realize M times N-plexer filters with respect to the first plurality of nodes 306-1 or with respect to signals flowing through these nodes. However, the multiple filters 134-1 to 134-F can present as or realize R times S-plexer filters with respect to the second plurality of nodes 306-2 or with respect to signals flowing through these nodes. The variables M, N, R, and S can take any integer greater than one, for instance. These values may be the same as each other or different from each other. These filter multiplexer arrangements are depicted in FIG. 3 with a first N-plexer 302-1, a second N-plexer 302-2, and an Mth N-plexer 302-M with respect to the first plurality of nodes 306-1, which are coupled to the at least one antenna port 268 in this example. The filter multiplexer arrangements are further depicted in FIG. 3 with a first S-plexer 304-1, a second S-plexer 304-2, a third S-plexer 304-3, and an Rth S-plexer 304-S with respect to the second plurality of nodes 306-2, which are coupled to the processing circuitry 308 in this example.

In example aspects, the M quantity of N-plexers can have multiple first band combinations, and the R quantity of S-plexers can have multiple second band combinations, with the multiple second band combinations different from the multiple first band combinations. The first plurality of nodes 306-1 may be coupled together into multiple first groups (e.g., including the first group 310-1) that differ from multiple second groups (e.g., including the second group 310-2) in which the second plurality of nodes 306-2 are coupled. Nonetheless, a quantity of the first plurality of nodes 306-1 and another quantity of the second plurality of nodes 306-2 may be equal. Accordingly, in example aspects, the multiple filters 134-1 to 134-F can have multiple filter ports (e.g., filter inputs or outputs) that are coupled to the second plurality of nodes 306-2 in accordance with the multiple second groups. These multiple filter ports can have a quantity of M times N or R times S.

As described herein, each multiplexing filter device may be represented as at least one N-plexer, an S-plexer, and so forth. Examples of such multiplexing filter devices include “unidirectional” n-plexers (e.g., a diplexer, triplexer, quadplexer, quintplexer, or more generally, a “diversity filter”) or “bidirectional” n-plexers (e.g., a duplexer). Thus, based at least partially on how filters are grouped in accordance with shared nodes, a multiplexing filter circuit 130 can include at least one frequency diversity filter, at least one duplex filter, combinations thereof, and so forth. Further, based on port sharing, a set of filters may be grouped into duplex filters from one perspective (e.g., from the antenna side) but grouped into diversity filters from another perspective (e.g., from an amplifier side).

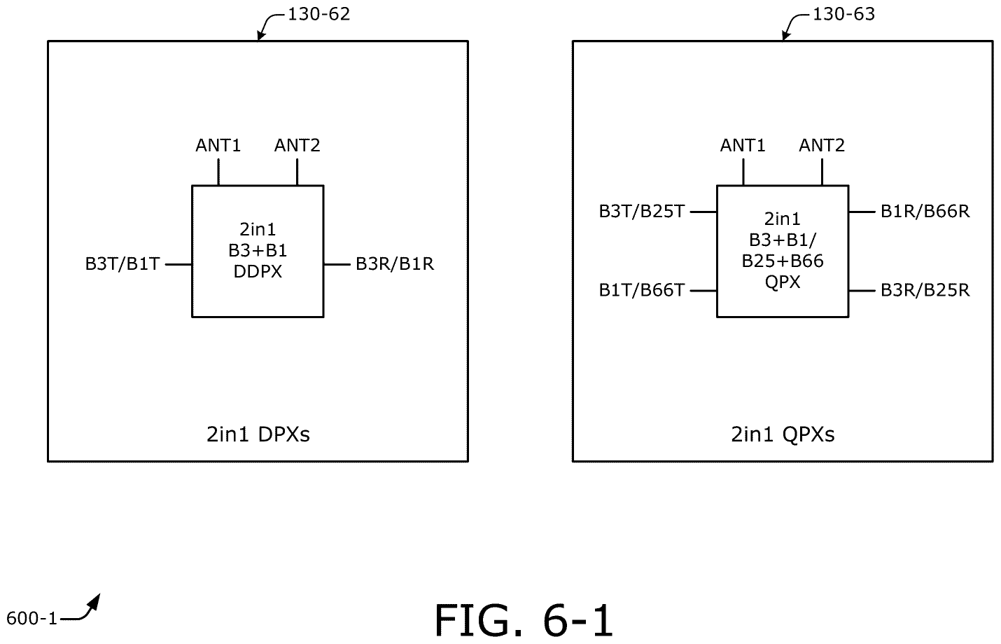

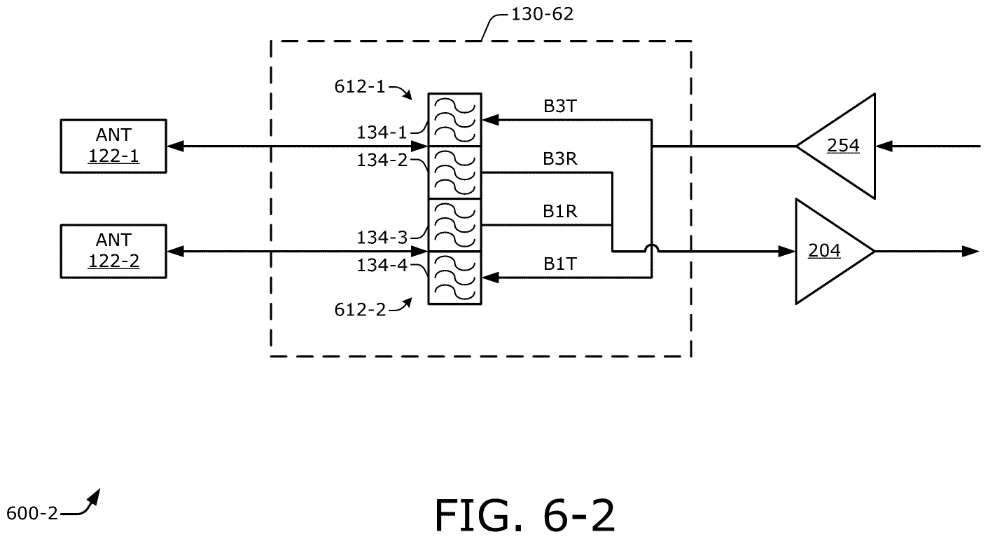

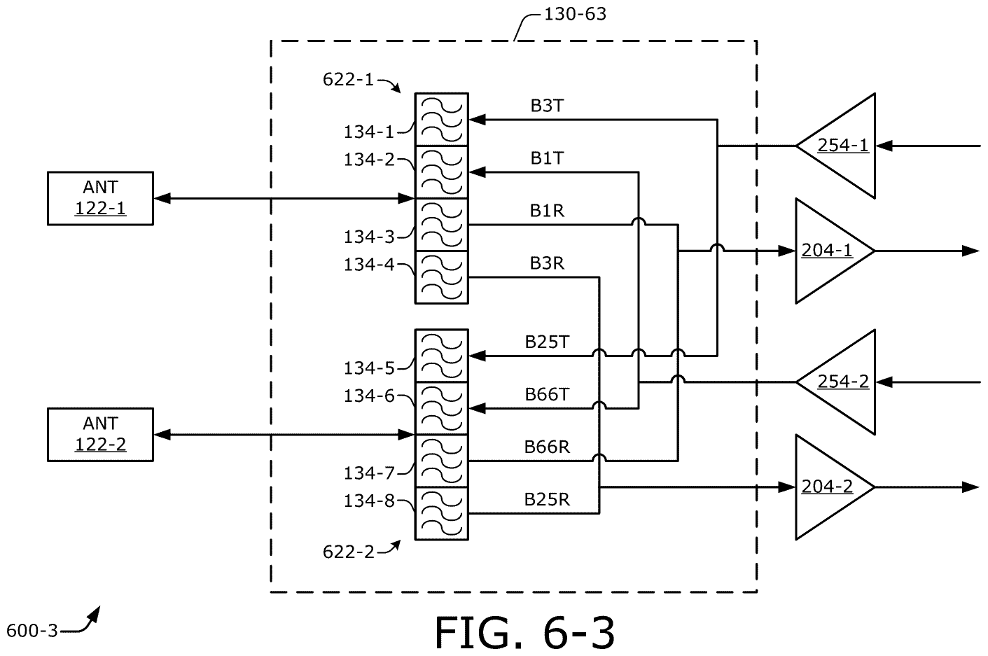

FIGS. 4-1, 4-2, and 4-3 are schematic diagrams 400-1, 400-2, and 400-3, respectively, illustrating example multiplexing filter circuits 130 with four filters 134-1 to 134-4 that are coupled between a switching circuit 262 and multiple amplifiers. Each filter 134 can be coupled to at least one amplifier (e.g., a low-noise amplifier 204 in FIG. 6-1 or a power amplifier 254 in FIG. 6-2) without an intervening switch to form an unswitched coupling, including an unswitched, electrical wireline coupling in some cases. The unswitched coupling can extend between the filter 134 and a shared input port 402 or shared output port 404. The unswitched coupling can further extend between the shared input port 402 or the shared output port 404 and the amplifier. With an unswitched coupling, another component (e.g., another filter or an impedance component like a capacitor or inductor) may be coupled between the filter and the amplifier, but the unswitched coupling omits a switch.

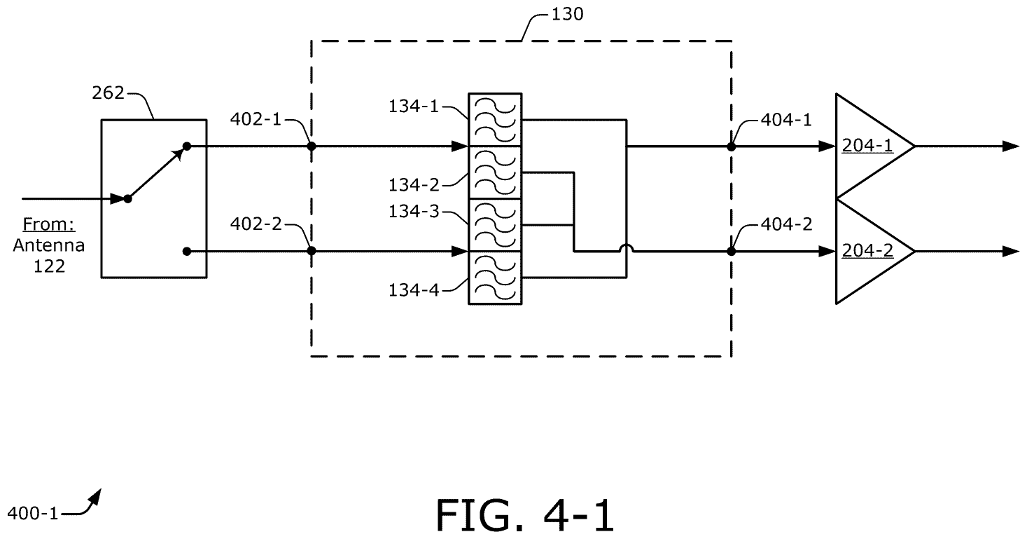

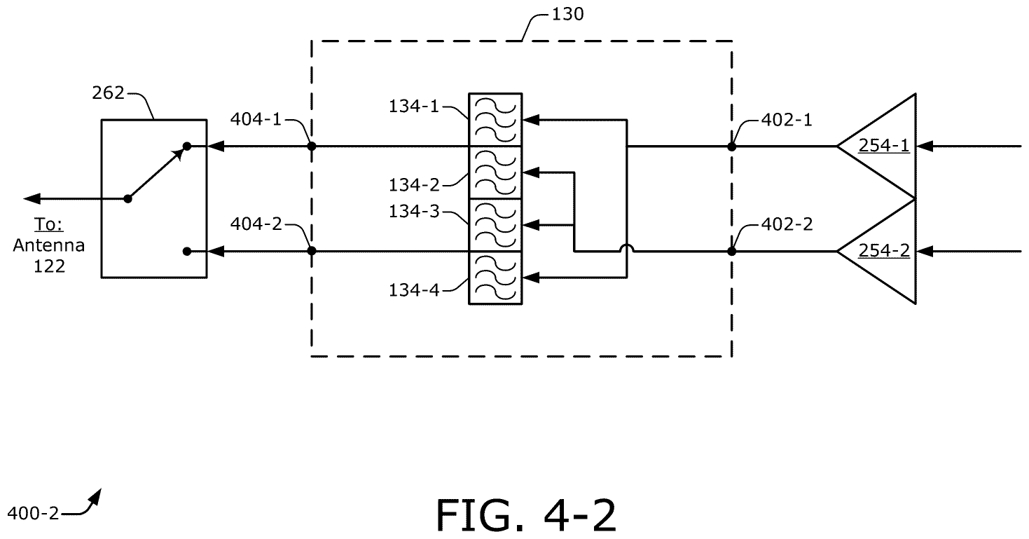

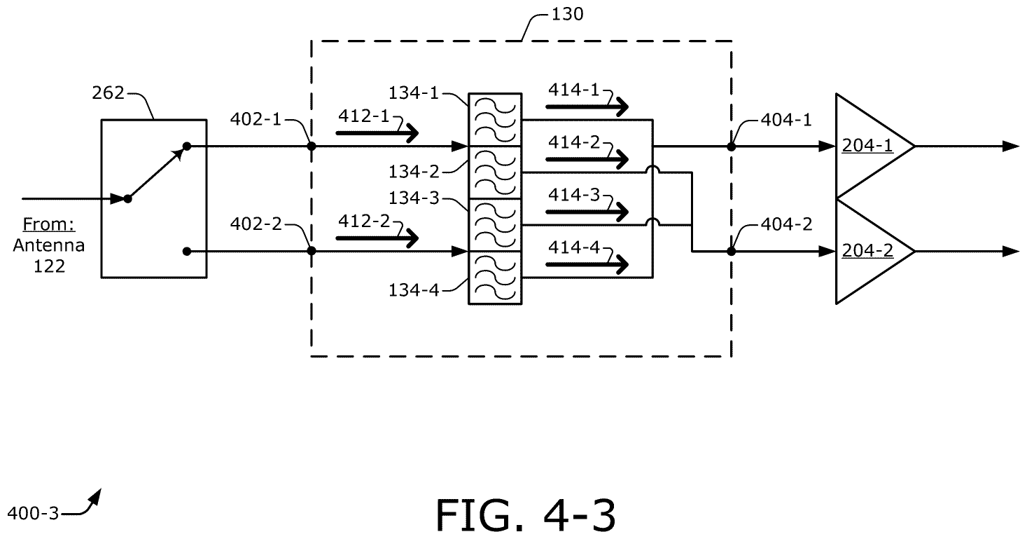

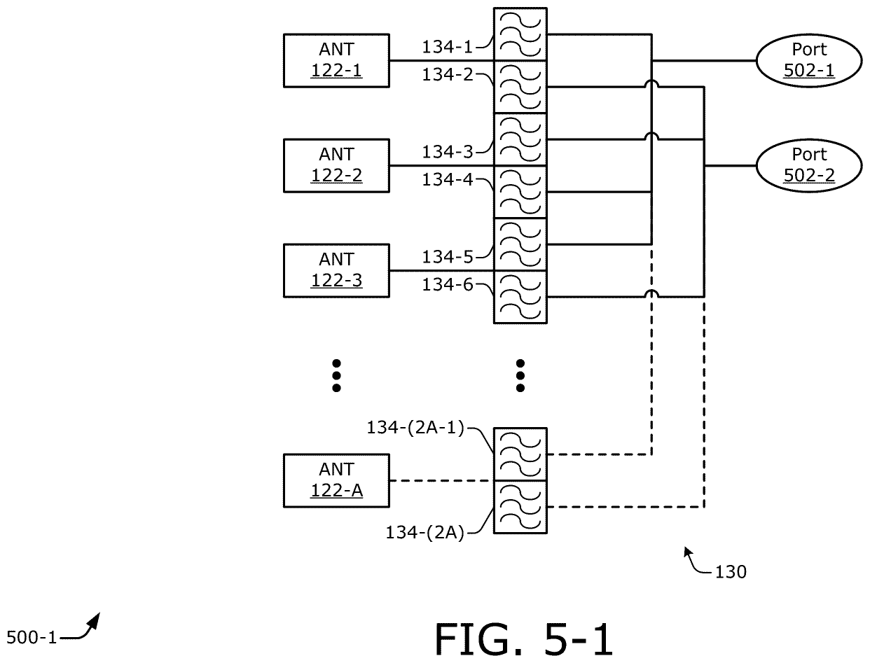

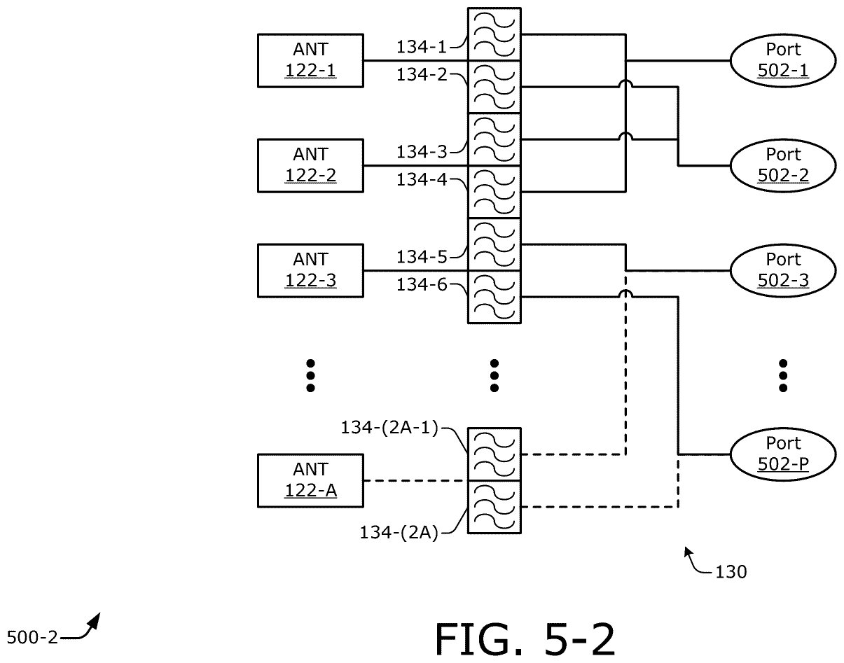

As illustrated in FIG. 4-1 for an example receive chain implementation, for filter inputs of the four filters, the first filter 134-1 and the second filter 134-2 have a first common input port 402-1 that is coupled to a first throw of the switching circuit 262. The third filter 134-3 and the fourth filter 134-4 have a second common input port 402-2 that is coupled to a second throw of the switching circuit 262. An input of the switching circuit 262 for the receive chain is coupled to at least one antenna 122 (not shown in FIG. 4-1). Thus, in example operations, a switching circuit 262 includes a switch input, a first switch output coupled to the first common input port 402-1, and a second switch output coupled to the second common input port 402-2. The switching circuit 262 can selectively couple the switch input to the first switch output and the second switch output, depending on the frequency or frequencies of at least one received signal.

As illustrated, for filter outputs of the four filters, the first filter 134-1 and the fourth filter 134-4 have a first common output port 404-1 that is coupled to an input of a first low-noise amplifier 204-1. The second filter 134-2 and the third filter 134-3 have a second common output port 404-2 that is coupled to an input of a second low-noise amplifier 204-2. These filters may have passbands corresponding to particular frequency bands. By way of example only, the first filter 134-1 may correspond to frequency band B3RX, and the second filter 134-2 may correspond to frequency band B66RX or B1RX; further, the third filter 134-3 may correspond to frequency band B39RX, and the fourth filter 134-4 may correspond to frequency band B41RX or B34RX. Other bands and band combinations, however, may be implemented. The illustrated shared or common ports may be realized with a plurality of nodes.

In example implementations, the four filters 134-1 to 134-4 can be arranged or organized into different filter groups to form different diplexers, including different diplexers from an input versus output perspective or from a signal flow perspective. From an input side, the four filters are coupled together as the following two filter groups that realize two diplexers: a first filter group or diplexer includes the first filter 134-1 and the second filter 134-2 as these two filters share the first common input port 402-1, and a second filter group or diplexer includes the third filter 134-3 and the fourth filter 134-4 as these two filters share the second common input port 402-2. From an output side, however, the four filters are coupled together as the following two different filter groups that realize two different diplexers: a first other diplexer (or third filter group or diplexer) includes the first filter 134-1 and the fourth filter 134-4 as these two filters share the first common output port 404-1, and a second other diplexer (or fourth filter group or diplexer) includes the second filter 134-2 and the third filter 134-3 as these two filters share the second common output port 404-2.

The purpose(s) or functionality of the diplexers may differ from one side as compared to the other side. Considering FIG. 4-1 by way of example, the diplexers “defined” from the antenna side can function to provide simultaneous operation by each filter (e.g., by both filters for a diplexer). For instance, for a diplexer formed by the first and second filters 134-1 and 134-2, the first and second filters 134-1 and 134-2 may be concurrently filtering a same signal arriving via the first common input port 402-1 to produce first and second signals (e.g., first and second output signals). On the other hand, the diplexers “defined” from the amplifier side can function such that each filter (e.g., both filters for a diplexer) operate at different times. For instance, for a diplexer formed by the second and third filters 134-2 and 134-3 that share the second common output port 404-2, these second and third filters 134-2 and 134-3 operate at disparate times on separate signals. Thus, one diplexer functionality relates to the two filters having a purpose of operating at the same time, but the other diplexer functionality relates to the two filters operating at different times but having a purpose of sharing a port or common node to reduce a component count. Although these two different purposes are described with reference to FIG. 4-1, they are applicable to other implementations, including those depicted in FIG. 4-2 and certain other figures.

FIG. 4-2 depicts an example transmit chain implementation. For filter outputs of the four filters, the first filter 134-1 and the second filter 134-2 have a first common output port 404-1 that is coupled to a first throw of the switching circuit 262. The third filter 134-3 and the fourth filter 134-4 have a second common output port 404-2 that is coupled to a second throw of the switching circuit 262. An output of the switching circuit 262 for the transmit chain is coupled to at least one antenna 122 (not shown in FIG. 4-2).

As illustrated, for filter inputs of the four filters, the first filter 134-1 and the fourth filter 134-4 have a first common input port 402-1 that is coupled to an output of a first power amplifier 254-1. The second filter 134-2 and the third filter 134-3 have a second common input port 402-2 that is coupled to an output of a second power amplifier 254-2. These filters may have passbands corresponding to particular frequency bands. By way of example only, the first filter 134-1 may correspond to band B3TX, and the second filter 134-2 may correspond to band B66TX or B1TX; further, the third filter 134-3 may correspond to band B39TX, and the fourth filter 134-4 may correspond to band B41TX or B34TX. Other bands and band combinations, however, may be implemented.

In example implementations, the four filters 134-1 to 134-4 can be arranged or organized into different groups to form different diplexers, including different diplexers from an input versus output perspective or from a signal flow perspective. From an output side, the four filters are coupled together as two diplexers: a first diplexer includes the first filter 134-1 and the second filter 134-2 based on a shared output node, and a second diplexer includes the third filter 134-3 and the fourth filter 134-4 based on another shared output node. From an input side, however, the four filters are coupled together as two different diplexers: a first other diplexer (or third diplexer) includes the first filter 134-1 and the fourth filter 134-4 based on a shared input node, and a second other diplexer (or fourth diplexer) includes the second filter 134-2 and the third filter 134-3 based on another shared input node.

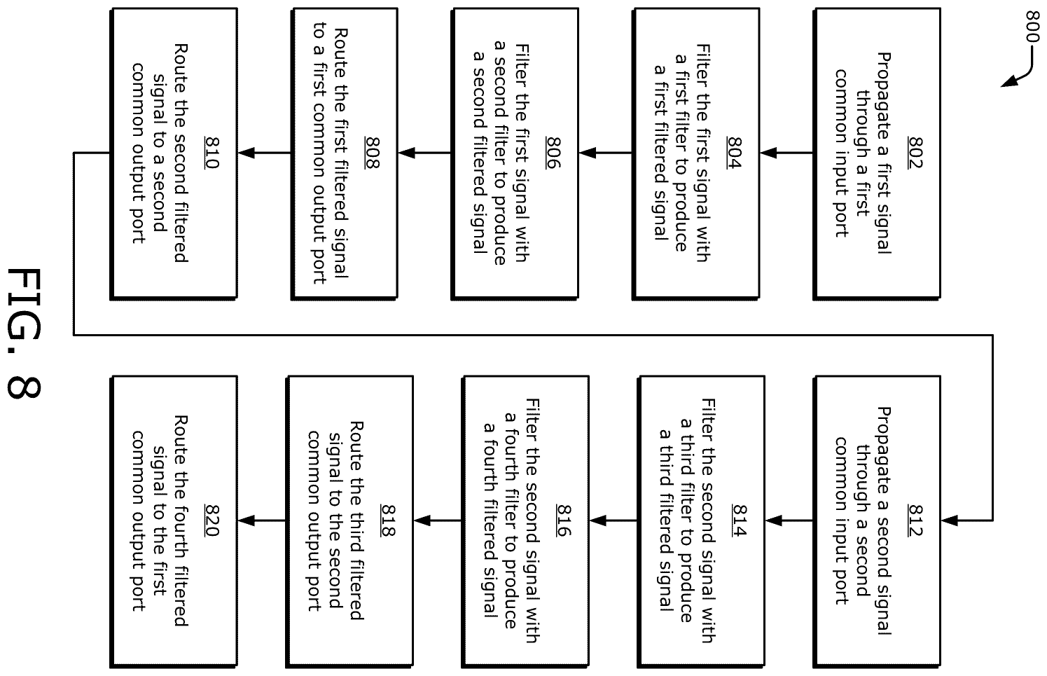

FIG. 4-3 depicts the example receive chain implementation of FIG. 4-1 with an overlay of multiple example signals. The schematic diagram 400-3 includes a first signal 412-1 and a second signal 412-2. These two signals correspond to received signals that are coupled from the switch 262 to the multiplexing filter circuit 130. The diagram also includes a first filtered signal 414-1, a second filtered signal 414-2, a third filtered signal 414-3, and a fourth filtered signal 414-4. These six example signals are referred to herein below with reference to the flow diagram of FIG. 8.

The example implementations of FIGS. 4-1 to 4-3 are described in an environment in which the multiplexing filter circuit 130 includes four filters that are arranged as two diplexers from input and output perspectives. Thus, with reference also to FIG. 3, the variables M, N, S, and R are all equal to two (2) for FIGS. 4-1 to 4-3. The principles of port sharing, however, are applicable to multiplexing filter circuits with a different total quantity of filters, to different groupings of filters into multiplexers with a different number of filters per multiplexer, to a different quantity of multiplexers on any or all sides (e.g., on either or both sides), and so forth. FIGS. 5-1 to 5-3 depict other arrangements for multiplexing filter circuits with different attributes.

FIGS. 5-1, 5-2, and 5-3 are schematic diagrams 500-1, 500-2, and 500-3, respectively, illustrating example multiplexing filter circuits with different quantities of filters and different couplings to antennas or shared ports. By way of example only, each multiplexing filter circuit 130 of FIGS. 5-1 to 5-3 includes multiple diplexers, such as A diplexers in which A is an integer greater than one. Accordingly, each multiplexing filter circuit 130 may be coupled to A antennas 122-1, 122-2, 122-3, . . . , 122-A, or A antenna ports 268 (of FIGS. 2-2 and 3). Each diplexer includes two filters. For example, a first diplexer can include filters 134-1 and 134-2, and a second diplexer can include filters 134-3 and 134-4. A third diplexer can include filters 134-5 and 134-6, and an Ath diplexer can include filters 134-(2A-1) and 134-(2A). Each filter 134 can be coupled to at least one port 502. Although FIGS. 5-1 to 5-3 are described in terms of diplexers, the couplings and operational principles are applicable to other multiplexers, such as duplexers and triplexers, just to name a couple of examples.

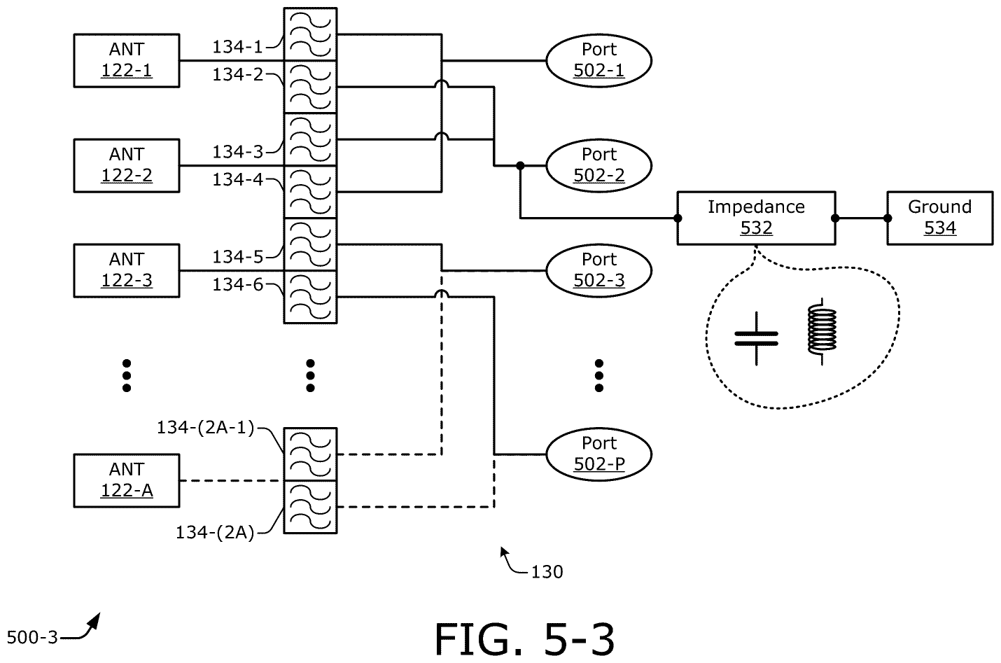

In FIG. 5-1, the example multiplexing filter circuit 130 includes two ports: a first port 502-1 and a second port 502-2. One filter of each diplexer is coupled to the first port 502-1, and another filter of each diplexer is coupled to the second port 502-2. For example, filters 134-1, 134-4, 134-5, and 134-(2A-1) are coupled to the first port 502-1. Similarly, filters 134-2, 134-3, 134-6, and 134-(2A) are coupled to the second port 502-2. With the schematic diagram 500-1, the multiplexing filter circuit 130 has two ports 502-1 and 502-2, and each diplexer is coupled to these same two ports.

In contrast with FIG. 5-1, in FIG. 5-2 every diplexer of the schematic diagram 500-2 is not coupled to the same two ports, and the multiplexing filter circuit 130 has more than two ports. As illustrated, the multiplexing filter circuit 130 includes P ports 502-1, 502-2, 502-3, . . . 502-P, with P being an integer greater than two in this instance. By way of example only, each port 502 can be coupled to two filters from two different diplexers. In the depicted example, the first port 502-1 is coupled to two filters 134-1 and 134-4 of two different diplexers from an antenna-side perspective, and the second port 502-2 is coupled to two filters 134-2 and 134-3 that are part of two diplexers from the antenna-side perspective. Each of these pairs of filters, however, may be grouped into, or be part of, the same respective diplexer from a port-side perspective. A third port 502-3 is coupled to two filters 134-5 and 134-(2A-1), and a Pth port 502-P is coupled to two filters 134-6 and 134-(2A). Thus, with the schematic diagram 500-2, the multiplexing filter circuit 130 may have two ports per pair of diplexers or two ports per four filters.

In FIG. 5-3, the schematic diagram 500-3 may be similar to the schematic diagram 500-2 of FIG. 5-2. The schematic diagram 500-3, however, depicts one or more other components that can facilitate the coupling together of filters from two “different” diplexers or n-plexers generally. For example, an impedance component 532 can be coupled to a common node for a shared port 502 (e.g., the second port 502-2). As shown, the impedance component 532 can be coupled between a common port and a ground 534 (e.g., a ground node or a ground plane). The impedance component 532 can ensure that a filter (e.g., the third filter 134-3) that is not currently active will not unduly load another filter (e.g., the second filter 134-2) that is currently active and in use for filtering a signal. The impedance component 532 can include, for instance, a capacitor, an inductor, a combination thereof, and so forth.

Generally, first and second filters can have one or more characteristics that reduce an impact of loading of the second filter on the first filter while the first filter is actively filtering a signal. For example, if two filters (e.g., of two different diplexers from the perspective of the antenna-side of the multiplexing filter circuit 130) of the filters 134-1 to 134-(2A) are realized with acoustic filters, the two filters can have attributes that are tailored to reduce mutual interference or loading. These attributes can be analogous to those used to reduce mutual interference or loading for two acoustic filters that are part of a same diplexer from the perspective of the antenna-side of the multiplexing filter circuit 130.

In some cases, to facilitate multifilter coupling to a shared port, frequency passbands of at least those filters that are coupled together can be non-overlapping to reduce potential issues with loading and adverse phase effects. For instance, different filters that are coupled together may correspond to different frequency bands. In some aspects, the frequency passbands of the filters of a multiplexing filter circuit 130, or at least a group of filters thereof, may also be distinct from each other. Here, filters may be grouped together from one perspective or side (or another perspective or side) based on being coupled to a shared or common port or node.

Alternatively, two or more filters that are sharing a same port can have overlapping frequency passbands. For example, two filters may have substantially similar frequency passbands. Two filters may, for instance, correspond to a same receive band B66R, which is depicted with an example multiplexing filter circuit 130-63 in FIGS. 6-1 and 6-3, which are described next.

FIGS. 6-1, 6-2, and 6-3 are block diagram 600-1 and schematic diagrams 600-2 and 600-3 of example multiplexing filter circuits that employ two duplexers or quadplexers. The description below refers to specific example frequency bands by way of example only. The circuitry and principles are applicable to other frequency bands.

In FIGS. 6-1 and 6-2, an example multiplexing filter circuit 130-62 includes two duplexers, such as two 2-in-1 duplexers (e.g., for bands B3+B1). Generally, the two duplexers can be coupled between two antennas (or antenna ports) and two amplifiers. By way of example only, a first antenna (ANT1) corresponds to two frequency bands: one transmit band B3T and one receive band B3R. A second antenna (ANT2) corresponds to two frequency bands: one transmit band B1T and one receive band B1R.

In FIG. 6-2, an example schematic diagram 600-2 includes two antennas 122-1 and 122-2, two duplexers, and two amplifiers. A first duplexer 612-1—from the antenna side perspective-includes first and second filters 134-1 and 134-2. A second duplexer 612-2—also from the antenna side perspective-includes third and fourth filters 134-3 and 134-4. The first duplexer 612-1 corresponds to band B3: the transmit band B3T and the receive band B3R. The second duplexer 612-2 corresponds to band B1: the transmit band B1T and the receive band B1R. From the amplifier side perspective, however, these four filters form two diplexers based on signal flows.

As shown in FIG. 6-2, for at least one receive path, a signal can be received via the first antenna 122-1, filtered by the second filter 134-2 in accordance with the receive band three (B3R), and amplified by a low-noise amplifier 204. Similarly, another signal can be received via the second antenna 122-2, filtered by the third filter 134-3 in accordance with the receive band one (B1R), and amplified by the low-noise amplifier 204. For at least one transmit path, a signal can be amplified by a power amplifier 254, filtered by the first filter 134-1 in accordance with the transmit band three (B3T), and emanated from the first antenna 122-1. Similarly, another signal can be amplified by the power amplifier 254, filtered by the fourth filter 134-4 in accordance with the transmit band one (BIT), and emanated from the second antenna 122-2.

In FIGS. 6-1 and 6-3, an example multiplexing filter circuit 130-63 includes two quadplexers, such as two 2-in-1 quadplexers (e.g., for bands B3+B1 and B25+B66). Generally, the two quadplexers can be coupled between two antennas (or antenna ports) and at least two amplifiers, such as the depicted four amplifiers. By way of example only, a first antenna (ANT1) corresponds to four frequency bands: a first transmit band B3T, a second transmit band B1T, a first receive band B1R, and a second receive band B3R. A second antenna (ANT2) corresponds to four frequency bands: a first transmit band B25T, a second transmit band B66T, a first receive band B66R, and a second receive band B25R.

In FIG. 6-3, an example schematic diagram 600-3 includes first and second antennas 122-1 and 122-2, two quadplexers, and four amplifiers. A first quadplexer 622-1—from the antenna side perspective-includes first, second, third, and fourth filters 134-1, 134-2, 134-3, and 134-4. A second quadplexer 622-2—from the antenna side perspective-includes fifth, sixth, seventh, and eighth filters 134-5, 134-6, 134-7, and 134-8. The first quadplexer 622-1 corresponds to the bands of the first antenna 122-1, and the second duplexer 622-2 corresponds to the bands of the second antenna 122-2.

As shown in FIG. 6-3, the first filter 134-1 and the fifth filter 134-5 can share a common input port, which is coupled to an output of a first power amplifier 254-1. The second filter 134-2 and the sixth filter 134-6 can share another common input port, which is coupled to an output of a second power amplifier 254-2. The third filter 134-3 and the seventh filter 134-7 can share a common output port, which is coupled to an input of a first low-noise amplifier 204-1. The fourth filter 134-4 and the eighth filter 134-8 can share another common output port, which is coupled to an input of a second power amplifier 204-2.

FIGS. 7-1, 7-2, and 7-3 are schematic diagrams 700-1, 700-2, and 700-3, respectively, of example multiplexing filter circuits 130 that employ multiple diplexers or duplexers that are coupled together in different manners. In the examples of FIGS. 7-1 to 7-3, frequency bands are represented generically, such as by a first transmit band TX1, a first receive band RX1, a second transmit band TX2, and a second receive band RX2.

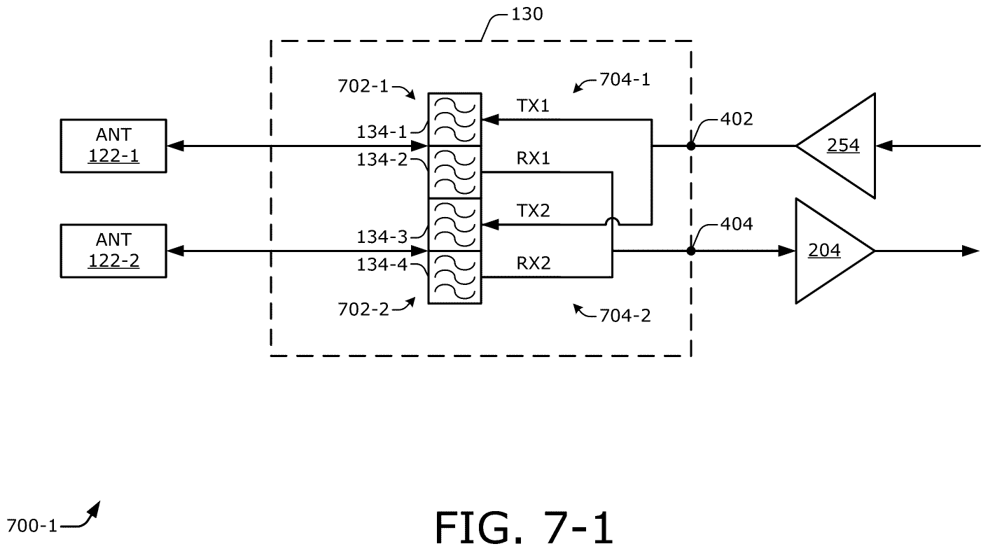

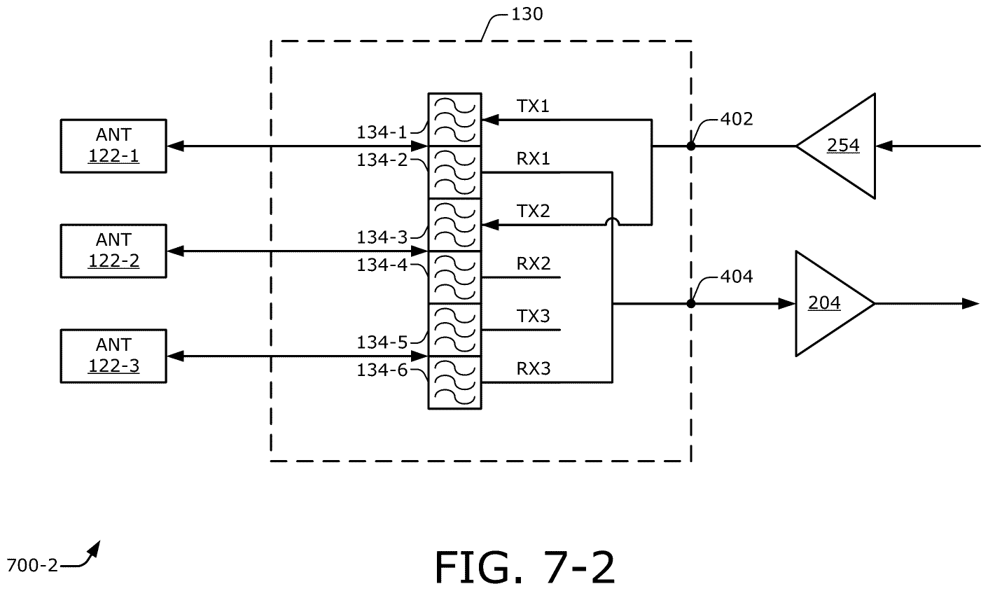

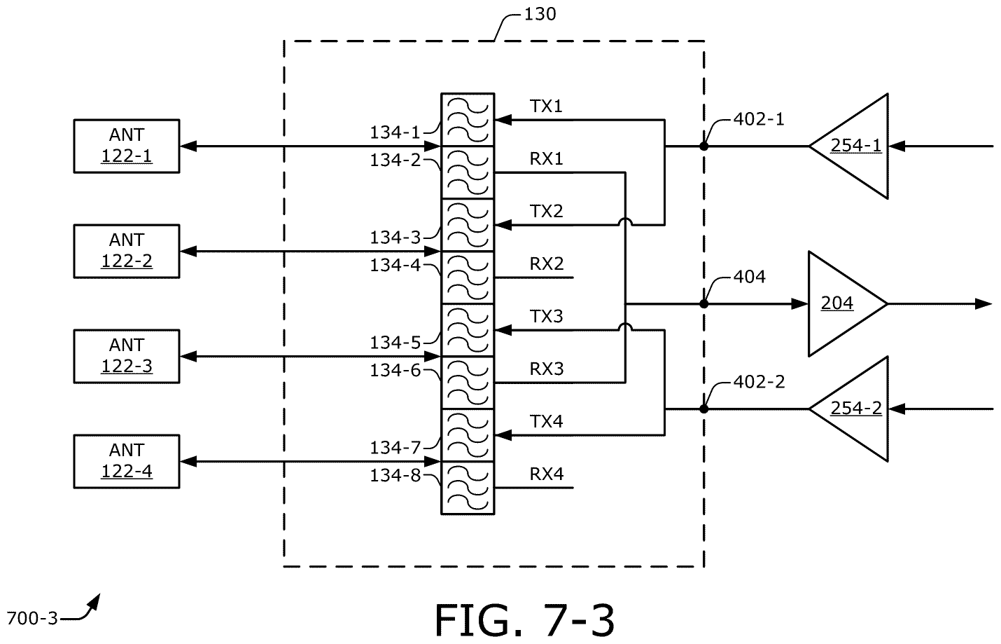

In FIG. 7-1, there are four filters 134-1 to 134-4 coupled to two antennas or antenna ports (not shown in FIG. 7-1). From the antenna side, the first and second filters 134-1 and 134-2 can form a first duplexer 702-1. Further, the third and fourth filters 134-3 and 134-4 can form a second duplexer 702-2. From the amplifier side, however, the second and fourth filters 134-2 and 134-4 can form a first diplexer 704-1, which is for reception. Similarly, the first and third filters 134-1 and 134-3 can form a second diplexer 704-2, which is for transmission.

In FIG. 7-2, there are six filters 134-1 to 134-6 coupled to three antennas or antenna ports (not shown in FIG. 7-2). Each pair of filters can form a duplexer. As illustrated, fewer than all filter nodes of the six filters may be coupled to a common node. Input filter nodes of the first and third filters 134-1 and 134-3 may be coupled to a shared input port 402. Output filter nodes of the second and sixth filters 134-2 and 134-6 may be coupled to a shared output port 404. The output filter node of the fourth filter 134-4 (for the second receive band RX2) and the input filter node of the fifth filter 134-5 (for the third transmit band TX3) may be respectively coupled to an input of another low-noise amplifier and an output of another power amplifier (not shown).

From the antenna side, the first and second filters 134-1 and 134-2 can form a first duplexer. Further, the third and fourth filters 134-3 and 134-4 can form a second duplexer, and the fifth and sixth filters 134-5 and 134-6 can form a third duplexer. From the amplifier side, however, the second and sixth filters 134-2 and 134-6 can form a first diplexer for reception via the shared output port 404. Similarly, the first and third filters 134-1 and 134-3 can form a second diplexer for transmission via the shared input port 402.

In FIG. 7-3, there are eight filters 134-1 to 134-8 coupled to four antennas or antenna ports (not shown in FIG. 7-3). As illustrated, fewer than all filter nodes of the eight filters may be coupled to a common node. Like FIG. 7-2, the input filter nodes of the first and third filters 134-1 and 134-3 may be coupled to a first shared input port 402-1. And the output filter nodes of the second and sixth filters 134-2 and 134-6 may be coupled to a shared output port 404. Additionally, the input filter nodes of the fifth and seventh filters 134-5 and 134-7 may be coupled to a second shared input port 402-2. Accordingly, the fifth and seventh filters 134-5 and 134-7 can form a diplexer for transmission operations via the second shared input port 402-2 from the amplifier side perspective.

FIG. 8 is a flow diagram illustrating an example process 800 for operating at least one multiplexing filter circuit. The process 800 includes ten blocks 802-820 that specify operations that can be performed for a method. However, operations are not necessarily limited to the order shown in the figures or described herein, for the operations may be implemented in alternative orders or in fully or partially overlapping manners. Also, more, fewer, and/or different operations may be implemented to perform a respective process or an alternative process.

In example implementations, operations represented by the illustrated blocks of each process may be performed by an electronic device, such as the electronic device 102 of FIG. 1 or the wireless interface device 120 thereof. More specifically, the operations of the respective processes may be performed by a multiplexing filter circuit 130 of a transceiver 126 or an RF front-end 128. Although some of the description herein focusses on filters that form diplexers for a receive chain, the described principles (e.g., corresponding to devices, circuitry, techniques, and processes) are not so limited. For instance, these principles are also applicable to n-plexers generally, to transmit chains, and to overlapped transmit and receive chains.

At block 802, a first signal is propagated through a first common input port. For example, an RF front-end 128 can propagate a first signal 412-1 through a first common input port 402-1. The first common input port 402-1 can be, for instance, part of a multiplexing filter circuit 130 or a node coupled to the multiplexing filter circuit 130.

At block 804, the first signal is filtered with a first filter to produce a first filtered signal. For example, a multiplexing filter circuit 130 can filter the first signal 412-1 with a first filter 134-1 to produce a first filtered signal 414-1. In some cases, the first filter 134-1 includes at least one microacoustic resonator.

At block 806, the first signal is filtered with a second filter to produce a second filtered signal. For example, the multiplexing filter circuit 130 can filter the first signal 412-1 with a second filter 134-2 to produce a second filtered signal 414-2. In such cases, the first common input port 402-1 can correspond to a shared node that is coupled to a filter input of the first filter 134-1 and a filter input of the second filter 134-2.

At block 808, the first filtered signal is routed to a first common output port. For example, the multiplexing filter circuit 130 can route the first filtered signal 414-1 to a first common output port 404-1. At block 810, the second filtered signal is routed to a second common output port. For example, the multiplexing filter circuit 130 can route the second filtered signal 414-2 to a second common output port 404-2. Thus, the first filter 134-1 and the second filter 134-2 can form a filter group that operates as a diplexer, at least from the perspective of the first common input port 402-1 on an antenna side of the multiplexing filter circuit 130.

At block 812, a second signal is propagated through a second common input port. For example, the RF front-end 128 can propagate a second signal 412-2 through a second common input port 402-2. This propagation may be performed at least partially by a switch 262.

At block 814, the second signal is filtered with a third filter to produce a third filtered signal. For example, the multiplexing filter circuit 130 can filter the second signal 412-2 with a third filter 134-3 to produce a third filtered signal 414-3. At block 816, the second signal is filtered with a fourth filter to produce a fourth filtered signal. For example, the multiplexing filter circuit 130 can filter the second signal 412-2 with a fourth filter 134-4 to produce a fourth filtered signal 414-4.

At block 818, the third filtered signal is routed to the second common output port. For example, the multiplexing filter circuit 130 can route the third filtered signal 414-3 to the second common output port 404-2. Thus, the second filter 134-2 and the third filter 134-3 can form another filter group that operates as a diplexer, at least from the perspective of the second common output port 404-2 on a circuit side of the multiplexing filter circuit 130.

At block 820, the fourth filtered signal is routed to the first common output port. For example, the multiplexing filter circuit 130 can route the fourth filtered signal 414-4 to the first common output port 404-1. Thus, the first filter 134-1 and the fourth filter 134-4 can form another filter group that operates as a diplexer, at least from the perspective of the first common output port 404-1 on a circuit side of the multiplexing filter circuit 130.

In example aspects, after the routing of the first filtered signal 414-1 to the first common output port 404-1, the first filtered signal 414-1 can be low-noise amplified by a first low-noise amplifier 204-1. Similarly, after the routing of the second filtered signal 414-2 to the second common output port 404-2, the second filtered signal 414-2 can be low-noise amplified by a second low-noise amplifier 204-2.

### Implementation Examples

This section describes some aspects of example implementations and/or example configurations related to the apparatuses and/or processes presented above.

Example aspect 1: An apparatus comprising:
at least one multiplexing filter circuit comprising multiple filters, each respective filter of the multiple filters having a respective distinct passband that corresponds to a frequency band, the multiple filters comprising a first group of filters and a second group of filters that is different from the first group of filters;
a first plurality of nodes coupled between the multiple filters and at least one antenna port, the first plurality of nodes comprising a first node coupled between the first group of filters and the at least one antenna port; and
a second plurality of nodes coupled between the multiple filters and processing circuitry, the second plurality of nodes comprising a first node coupled between the second group of filters and the processing circuitry,
the first group of filters and the second group of filters each comprising at least one filter of the multiple filters in common.

Example aspect 2: The apparatus of example aspect 1, wherein:
the multiple filters comprise a first filter, a second filter, and a third filter;
the first group of filters comprises the first filter and the second filter; and
the second group of filters comprises the second filter and the third filter.

Example aspect 3: The apparatus of example aspect 2, wherein:
the multiple filters comprise a fourth filter, a third group of filters, and a fourth group of filters;
the third group of filters comprises the third filter and the fourth filter; and
the fourth group of filters comprises the first filter and the fourth filter.

Example aspect 4: The apparatus of example aspect 3, wherein:
a second node of the first plurality of nodes is coupled between the third group of filters and the at least one antenna port; and
a second node of the second plurality of nodes is coupled between the fourth group of filters and the processing circuitry.

Example aspect 5: The apparatus of example aspect 4, wherein:
the processing circuitry comprises multiple amplifiers, including a first amplifier and a second amplifier;
the first amplifier is coupled to the first node of the second plurality of nodes; and
the second amplifier is coupled to the second node of the second plurality of nodes.

Example aspect 6: The apparatus of example aspect 5, wherein:
the first amplifier comprises a first low-noise amplifier, and the second amplifier comprises a second low-noise amplifier;
an input of the first low-noise amplifier is coupled to the first node of the second plurality of nodes; and
an input of the second low-noise amplifier is coupled to the second node of the second plurality of nodes.

Example aspect 7: The apparatus of example aspect 5, wherein:
the first amplifier comprises a first power amplifier, and the second amplifier comprises a second power amplifier;
an output of the first power amplifier is coupled to the first node of the second plurality of nodes; and
an output of the second power amplifier is coupled to the second node of the second plurality of nodes.

Example aspect 8: The apparatus of example aspect 3, wherein:
the first group of filters comprises a first diplexer;
the second group of filters comprises a second diplexer;
the third group of filters comprises a third diplexer; and
the fourth group of filters comprises a fourth diplexer.

Example aspect 9: The apparatus of any one of the preceding example aspects, wherein:
the first group of filters comprises a first n-plexer;
the second group of filters comprises a second n-plexer; and
the at least one filter of the multiple filters is part of the first n-plexer and part of the second n-plexer.

Example aspect 10: The apparatus of any one of the preceding example aspects, wherein:
the first group of filters is defined relative to an antenna side of the at least one multiplexing circuit, the antenna side corresponding to the first plurality of nodes and the at least one antenna port; and
the second group of filters is defined relative to a processing side of the at least one multiplexing circuit, the processing side corresponding to the second plurality of nodes and the processing circuitry.

Example aspect 11: An apparatus comprising:
a first filter and a second filter each coupled to a first common input port that is common to the first filter and the second filter, the first filter comprising a first filter output, and the second filter comprising a second filter output;
a third filter and a fourth filter each coupled to a second common input port that is common to the third filter and the fourth filter, the third filter comprising a third filter output coupled to the second filter output to form a first common output port, and the fourth filter comprising a fourth filter output coupled to the first filter output to form a second common output port;
a first low-noise amplifier comprising an input coupled to the first common output port;
a second low-noise amplifier comprising an input coupled to the second common output port; and
a switching circuit comprising a switch input, a first switch output coupled to the first common input port, and a second switch output coupled to the second common input port, the switching circuit configured to selectively couple the switch input to the first switch output and the second switch output.

Example aspect 12: The apparatus of example aspect 11, wherein:
a first filter response of the first filter corresponds to a first frequency band, and a second filter response of the second filter corresponds to a second frequency band;
the first frequency band and the second frequency band correspond to a first active carrier aggregation combination;
a third filter response of the third filter corresponds to a third frequency band, and a fourth filter response of the fourth filter corresponds to a fourth frequency band; and
the third frequency band and the fourth frequency band correspond to a second active carrier aggregation combination different from the first active carrier aggregation combination.

Example aspect 13: The apparatus of example aspect 12, wherein:
the second frequency band and the third frequency band are nonadjacent to each other; and
the first frequency band and the fourth frequency band are nonadjacent to each other.

Example aspect 14: The apparatus of example aspect 12, wherein:
the first active carrier aggregation combination is active at a first time; and
the second active carrier aggregation combination is active at a second time different from the first time.

Example aspect 15: The apparatus of any one of example aspects 11-14, wherein:
at least one of the second filter or the third filter has one or more characteristics configured to reduce an impact of loading of the third filter on the second filter while the second filter is actively filtering a signal.

Example aspect 16: The apparatus of any one of example aspects 11-15, wherein:
a passband of the second filter is nonoverlapping with a passband of the third filter.

Example aspect 17: The apparatus of any one of example aspects 11-16, wherein:
an impedance component is coupled between the first common output port and a ground.

Example aspect 18: The apparatus of example aspect 17, wherein:
the impedance component comprises at least one of an inductor or a capacitor.

Example aspect 19: A method comprising:
propagating a first signal through a first common input port;
filtering the first signal with a first filter to produce a first filtered signal;
filtering the first signal with a second filter to produce a second filtered signal;
routing the first filtered signal to a first common output port;
routing the second filtered signal to a second common output port;
propagating a second signal through a second common input port;
filtering the second signal with a third filter to produce a third filtered signal;
filtering the second signal with a fourth filter to produce a fourth filtered signal;
routing the third filtered signal to the second common output port; and
routing the fourth filtered signal to the first common output port.

Example aspect 20: The method of example aspect 19, further comprising:
after the routing of the first filtered signal to the first common output port, low-noise amplifying the first filtered signal; and
after the routing of the second filtered signal to the second common output port, low-noise amplifying the second filtered signal.

Example aspect 21: An apparatus comprising:
at least one multiplexing filter circuit comprising multiple filters, each respective filter of the multiple filters corresponding to a respective distinct passband that is associated with a respective frequency band, the multiple filters comprising a first set of filters forming at least a first filter group and a second set of filters forming at least a second filter group, the first filter group different from the second filter group;
a first plurality of nodes coupled between the first set of filters and at least one antenna port; and
a second plurality of nodes coupled between the second set of filters and processing circuitry.

Example aspect 22: The apparatus of example aspect 21, wherein:
the multiple filters comprise a first filter, a second filter, and a third filter;
the first filter group comprises the first filter and the second filter; and
the second filter group comprises the second filter and the third filter.

Example aspect 23: The apparatus of example aspect 22, wherein:
the multiple filters comprise a fourth filter;
the first set of filters comprises a third filter group;
the second set of filters comprises a fourth filter group;
the third filter group comprises the third filter and the fourth filter; and
the fourth filter group comprises the first filter and the fourth filter.

Example aspect 24: The apparatus of example aspect 23, wherein:
a first node of the first plurality of nodes is coupled between the first filter group and the at least one antenna port;
a second node of the first plurality of nodes is coupled between the third filter group and the at least one antenna port;
a first node of the second plurality of nodes is coupled between the second filter group and the processing circuitry; and
a second node of the second plurality of nodes is coupled between the fourth filter group and the processing circuitry.

Example aspect 25: The apparatus of example aspect 24, wherein:
the processing circuitry comprises multiple amplifiers, including a first amplifier and a second amplifier;
the first amplifier is coupled to the first node of the second plurality of nodes; and
the second amplifier is coupled to the second node of the second plurality of nodes.

Example aspect 26: The apparatus of example aspect 25, wherein:
the first amplifier comprises a first low-noise amplifier, and the second amplifier comprises a second low-noise amplifier;
an input of the first low-noise amplifier is coupled to the first node of the second plurality of nodes; and
an input of the second low-noise amplifier is coupled to the second node of the second plurality of nodes.

Example aspect 27: The apparatus of example aspect 25, wherein:
the first amplifier comprises a first power amplifier, and the second amplifier comprises a second power amplifier;
an output of the first power amplifier is coupled to the first node of the second plurality of nodes; and
an output of the second power amplifier is coupled to the second node of the second plurality of nodes.

Example aspect 28: The apparatus of any one of example aspects 23-27, wherein, with respect the first plurality of nodes:
the first filter group comprises a first diplexer; and
the third filter group comprises a second diplexer different from the first diplexer.

Example aspect 29: The apparatus of example aspect 28, wherein, with respect the second plurality of nodes:
the second filter group comprises a third diplexer different from the first and second diplexers; and
the fourth filter group comprises a fourth diplexer different from the first, second, and third diplexers.

Example aspect 30: The apparatus of any one of example aspects 23-29, wherein:
the first filter group corresponds to a first band combination;
the second filter group corresponds to a second band combination different from the first band combination;
the third filter group corresponds to a third band combination different from the first and second band combinations; and
the fourth filter group corresponds to a fourth band combination different from the first, second, and third band combinations.

Example aspect 31: The apparatus of any one of example aspects 21-30, wherein:
each node of the first plurality of nodes is coupled to at least two filters of the first set of filters; and
each node of the second plurality of nodes is coupled to at least two filters of the second set of filters.

Example aspect 32: The apparatus of any one of example aspects 21-31, wherein:
each node of the first plurality of nodes is coupled to at least two filters of the first filter group; and
each node of the second plurality of nodes is coupled to at least two filters of the second filter group.

Example aspect 33: The apparatus of any one of example aspects 21-32, wherein the first set of filters and the second set of filters comprise a same set of filters.

Example aspect 34: The apparatus of any one of example aspects 21-33, wherein:
the first filter group corresponds to a first band combination; and
the second filter group corresponds to a second band combination different from the first band combination.

Example aspect 35: The apparatus of any one of example aspects 21-34, wherein each respective distinct passband of each respective filter of the multiple filters is non-overlapping with respect to each other distinct passband of each other filter of the multiple filters.

Example aspect 36: The apparatus of any one of example aspects 21-35, wherein each filter of the multiple filters comprises a radio-frequency filter.

Example aspect 37: The apparatus of any one of example aspects 21-36, wherein each filter of the multiple filters comprises a microacoustic filter including at least one microacoustic resonator.

Example aspect 38: The apparatus of any one of example aspects 21-37, further comprising:
a radio-frequency front-end comprising the at least one multiplexing filter circuit.

Example aspect 39: The apparatus of example aspect 38, further comprising:
a wireless interface device comprising the radio-frequency front-end;
a display screen; and
at least one processor operatively coupled to the display screen and at least a portion of the wireless interface device, the at least one processor configured to present one or more graphical images on the display screen based on one or more wireless signals communicated using the at least one multiplexing filter circuit of the wireless interface device.

Example aspect 40: An apparatus comprising:
a first plurality of nodes;
a second plurality of nodes; and
a multiplexing filter circuit coupled between the first plurality of nodes and the second plurality of nodes, the multiplexing filter circuit comprising multiple filters configured to:
   present as M times N-plexer filters with respect to the first plurality of nodes; and
   present as R times S-plexer filters with respect to the second plurality of nodes.

Example aspect 41: The apparatus of example aspect 40, wherein:
the M times N-plexer filters have multiple first band combinations; and
the R times S-plexer filters have multiple second band combinations different from the multiple first band combinations.

Example aspect 42: The apparatus of example aspect 40 or 41, wherein:
the multiple filters have multiple filter ports coupled to the second plurality of nodes; and
the multiple filter ports, which are coupled to the second plurality of nodes, have a quantity of M times N.

Example aspect 43: An apparatus comprising:
a first filter and a second filter each coupled to a first common input port that is common to the first filter and the second filter, the first filter having a first filter output, and the second filter having a second filter output;
a third filter and a fourth filter each coupled to a second common input port that is common to the third filter and the fourth filter, the third filter having a third filter output coupled to the second filter output to form a first common output port, and the fourth filter having a fourth filter output coupled to the first filter output to form a second common output port;
a first low-noise amplifier having an input coupled to the first common output port;
a second low-noise amplifier having an input coupled to the second common output port; and
a switching circuit having a switch input, a first switch output coupled to the first common input port, and a second switch output coupled to the second common input port, the switching circuit configured to selectively couple the switch input to the first switch output and the second switch output.

Example aspect 44: The apparatus of example aspect 43, wherein:
a first filter response of the first filter corresponds to a first band, and a second filter response of the second filter corresponds to a second band;
the first band and the second band correspond to a first active carrier aggregation combination;
a third filter response of the third filter corresponds to a third band, and a fourth filter response of the fourth filter corresponds to a fourth band; and
the third band and the fourth band correspond to a second active carrier aggregation combination different from the first active carrier aggregation combination.

Example aspect 45: The apparatus of example aspect 44, wherein:
the second band and the third band are nonadjacent; and
the first band and the fourth band are nonadjacent.

Example aspect 46: The apparatus of example aspect 44 or 45, wherein:
the first active carrier aggregation combination is active at a first time; and
the second active carrier aggregation combination is active at a second time different from the first time.

Example aspect 47: The apparatus of any one of example aspects 43-46, wherein:
at least one of the second filter or the third filter has one or more characteristics configured to reduce an impact of loading of the third filter on the second filter while the second filter is actively filtering a signal.

Example aspect 48: The apparatus of any one of example aspects 43-47, wherein:
a passband of the second filter is nonoverlapping with a passband of the third filter.

Example aspect 49: The apparatus of any one of example aspects 43-48, wherein:
an impedance component is coupled between the first common output port and a ground.

Example aspect 50: The apparatus of example aspect 49, wherein:
the impedance component comprises at least one of an inductor or a capacitor.

Example aspect 51: An apparatus comprising:
at least one filter circuit comprising multiple filters, each respective filter of the multiple filters including a respective distinct passband that corresponds with a frequency band, the multiple filters comprising a first group of filters and a second group of filters that is different from the first group of filters;
a first plurality of nodes coupled between the first group of filters and at least one antenna port; and
a second plurality of nodes coupled between the second group of filters and processing circuitry.

Example aspect 52: The apparatus of example aspect 51, wherein:
the multiple filters comprise a first filter, a second filter, and a third filter;
the first group of filters comprises the first filter and the second filter; and
the second group of filters comprises the second filter and the third filter.

Example aspect 53: The apparatus of example aspect 52, wherein:
the multiple filters comprise a fourth filter, a third group of filters, and a fourth group of filters;
the third group of filters comprises the third filter and the fourth filter; and
the fourth group of filters comprises the first filter and the fourth filter.

Example aspect 54: The apparatus of example aspect 53, wherein:
a first node of the first plurality of nodes is coupled between the first group of filters and the at least one antenna port;
a second node of the first plurality of nodes is coupled between the third group of filters and the at least one antenna port;
a first node of the second plurality of nodes is coupled between the second group of filters and the processing circuitry; and
a second node of the second plurality of nodes is coupled between the fourth group of filters and the processing circuitry.

Example aspect 55: The apparatus of example aspect 54, wherein:
the processing circuitry comprises multiple amplifiers, including a first amplifier and a second amplifier;
the first amplifier is coupled to the first node of the second plurality of nodes; and
the second amplifier is coupled to the second node of the second plurality of nodes.

Example aspect 56: The apparatus of example aspect 55, wherein:
the first amplifier comprises a first low-noise amplifier, and the second amplifier comprises a second low-noise amplifier;
an input of the first low-noise amplifier is coupled to the first node of the second plurality of nodes; and
an input of the second low-noise amplifier is coupled to the second node of the second plurality of nodes.

Example aspect 57: The apparatus of example aspect 55, wherein:
the first amplifier comprises a first power amplifier, and the second amplifier comprises a second power amplifier;
an output of the first power amplifier is coupled to the first node of the second plurality of nodes; and
an output of the second power amplifier is coupled to the second node of the second plurality of nodes.

Example aspect 58: The apparatus of example aspect 53, wherein:
the first group of filters comprises a first diplexer; and
the third group of filters comprises a second diplexer.

Example aspect 59: A method comprising:
propagating a first signal through a first common ingress port;
filtering the first signal with a first filter to produce a first filtered signal;
filtering the first signal with a fourth filter to produce a fourth filtered signal;
propagating a second signal through a second common ingress port;
filtering the second signal with a second filter to produce a second filtered signal;
filtering the second signal with a third filter to produce a third filtered signal;
routing the first filtered signal to a first common egress port;
routing the fourth filtered signal to a second common egress port;
routing the second filtered signal to the first common egress port; and
routing the third filtered signal to the second common egress port.

Example aspect 60: The method of example aspect 59, further comprising:
prior to the propagating of the first signal through the first common ingress port, low-noise amplifying the first signal; and
prior to the propagating of the second signal through the second common ingress port, low-noise amplifying the second signal.

### CONCLUSION

As used herein, the terms “couple,” “coupled,” or “coupling” refer to a relationship between two or more components that are in operative communication with each other to implement some feature or realize some capability that is described herein. The coupling can be realized using, for instance, a physical line, such as a metal trace or wire, or an electromagnetic coupling, such as with a transformer. A coupling can include a direct coupling or an indirect coupling. A direct coupling refers to connecting discrete circuit elements via a same node without an intervening element. An indirect coupling refers to connecting discrete circuit elements via one or more other devices or other discrete circuit elements, including two or more different nodes.

The term “port” (e.g., including a “first port” or a “filter port”) represents at least a point of electrical connection at or proximate to the input or output of a component or between two or more components (e.g., active or passive circuit elements or parts). Although at times a port may be visually depicted in a drawing as a single point (or a circle), the port can represent an inter-connected portion of a physical circuit or network that has at least approximately a same voltage potential at or along the portion. In other words, a single-ended port can represent at least one point (e.g., a node) of multiple points along a conducting medium (e.g., a wire or trace) that exists between electrically connected components. In some cases, a “port” can represent at least one node that represents or corresponds to an input or an output of a component, such as a filter or part thereof. Similarly, a “terminal” or a “node” may represent one or more points with at least approximately a same voltage potential relative to an input or output of a component.

The terms “first,” “second,” “third,” and other numeric-related indicators are used herein to identify or distinguish similar or analogous items from one another within a given context—such as a particular implementation, a single drawing figure, a given component, or a claim. Thus, a first item in one context may differ from a first item in another context. For example, an item identified as a “first filter” in one context may be identified as a “second filter” in another context. Similarly, a “first shared port” or a “first common node” in one claim may be recited as a “second shared port” or a “third common node,” respectively, in a different claim.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for realizing a multiplexing filter circuit with shared ports have been described in language specific to certain features and/or methods, the subject of the appended claims is not necessarily limited to the specific features or methods described. Rather, the specific features and methods are disclosed as example implementations for realizing a multiplexing filter circuit with shared ports.

What is claimed is:

1. An apparatus comprising:
at least one multiplexing filter circuit comprising multiple filters, each respective filter of the multiple filters having a respective distinct passband that corresponds to a frequency band, the multiple filters comprising a first group of filters and a second group of filters that is different from the first group of filters;
a first plurality of nodes coupled between the multiple filters and at least one antenna port, the first plurality of nodes comprising a first node coupled between the first group of filters and the at least one antenna port; and
a second plurality of nodes coupled between the multiple filters and processing circuitry, the second plurality of nodes comprising a first node coupled between the second group of filters and the processing circuitry,
the first group of filters and the second group of filters each comprising at least one filter of the multiple filters in common.

2. The apparatus of claim 1, wherein:
the multiple filters comprise a first filter, a second filter, and a third filter;
the first group of filters comprises the first filter and the second filter; and
the second group of filters comprises the second filter and the third filter.

3. The apparatus of claim 2, wherein:
the multiple filters comprise a fourth filter, a third group of filters, and a fourth group of filters;
the third group of filters comprises the third filter and the fourth filter; and
the fourth group of filters comprises the first filter and the fourth filter.

4. The apparatus of claim 3, wherein:
a second node of the first plurality of nodes is coupled between the third group of filters and the at least one antenna port; and
a second node of the second plurality of nodes is coupled between the fourth group of filters and the processing circuitry.

5. The apparatus of claim 4, wherein:
the processing circuitry comprises multiple amplifiers, including a first amplifier and a second amplifier;
the first amplifier is coupled to the first node of the second plurality of nodes; and
the second amplifier is coupled to the second node of the second plurality of nodes.

6. The apparatus of claim 5, wherein:
the first amplifier comprises a first low-noise amplifier, and the second amplifier comprises a second low-noise amplifier;
an input of the first low-noise amplifier is coupled to the first node of the second plurality of nodes; and
an input of the second low-noise amplifier is coupled to the second node of the second plurality of nodes.

7. The apparatus of claim 5, wherein:
the first amplifier comprises a first power amplifier, and the second amplifier comprises a second power amplifier;
an output of the first power amplifier is coupled to the first node of the second plurality of nodes; and
an output of the second power amplifier is coupled to the second node of the second plurality of nodes.

8. The apparatus of claim 3, wherein:
the first group of filters comprises a first diplexer;
the second group of filters comprises a second diplexer;
the third group of filters comprises a third diplexer; and
the fourth group of filters comprises a fourth diplexer.

9. The apparatus of claim 1, wherein:
the first group of filters comprises a first n-plexer;
the second group of filters comprises a second n-plexer; and
the at least one filter of the multiple filters is part of the first n-plexer and part of the second n-plexer.

10. The apparatus of claim 1, wherein:
the first group of filters is defined relative to an antenna side of the at least one multiplexing circuit, the antenna side corresponding to the first plurality of nodes and the at least one antenna port; and
the second group of filters is defined relative to a processing side of the at least one multiplexing circuit, the processing side corresponding to the second plurality of nodes and the processing circuitry.

11. An apparatus comprising:
a first filter and a second filter each coupled to a first common input port that is common to the first filter and the second filter, the first filter comprising a first filter output, and the second filter comprising a second filter output;
a third filter and a fourth filter each coupled to a second common input port that is common to the third filter and the fourth filter, the third filter comprising a third filter output coupled to the second filter output to form a first common output port, and the fourth filter comprising a fourth filter output coupled to the first filter output to form a second common output port;
a first low-noise amplifier comprising an input coupled to the first common output port;
a second low-noise amplifier comprising an input coupled to the second common output port; and
a switching circuit comprising a switch input, a first switch output coupled to the first common input port, and a second switch output coupled to the second common input port, the switching circuit configured to selectively couple the switch input to the first switch output and the second switch output.

12. The apparatus of claim 11, wherein:
a first filter response of the first filter corresponds to a first frequency band, and a second filter response of the second filter corresponds to a second frequency band;
the first frequency band and the second frequency band correspond to a first active carrier aggregation combination;
a third filter response of the third filter corresponds to a third frequency band, and a fourth filter response of the fourth filter corresponds to a fourth frequency band; and
the third frequency band and the fourth frequency band correspond to a second active carrier aggregation combination different from the first active carrier aggregation combination.

13. The apparatus of claim 12, wherein:
the second frequency band and the third frequency band are nonadjacent to each other; and
the first frequency band and the fourth frequency band are nonadjacent to each other.

14. The apparatus of claim 12, wherein:
the first active carrier aggregation combination is active at a first time; and
the second active carrier aggregation combination is active at a second time different from the first time.

15. The apparatus of claim 11, wherein:
at least one of the second filter or the third filter has one or more characteristics configured to reduce an impact of loading of the third filter on the second filter while the second filter is actively filtering a signal.

16. The apparatus of claim 15, wherein:
a passband of the second filter is nonoverlapping with a passband of the third filter.

17. The apparatus of claim 11, wherein:
an impedance component is coupled between the first common output port and a ground.

18. The apparatus of claim 17, wherein:
the impedance component comprises at least one of an inductor or a capacitor.

19. A method comprising:
propagating a first signal through a first common input port;
filtering the first signal with a first filter to produce a first filtered signal;
filtering the first signal with a second filter to produce a second filtered signal;
routing the first filtered signal to a first common output port;
routing the second filtered signal to a second common output port;
propagating a second signal through a second common input port;
filtering the second signal with a third filter to produce a third filtered signal;
filtering the second signal with a fourth filter to produce a fourth filtered signal;
routing the third filtered signal to the second common output port; and
routing the fourth filtered signal to the first common output port.

20. The method of claim 19, further comprising:
after the routing of the first filtered signal to the first common output port, low-noise amplifying the first filtered signal; and
after the routing of the second filtered signal to the second common output port, low-noise amplifying the second filtered signal.
